(19) United States
(12) Patent Application Publication
(10) Pub. No.: US 2007/0038939 A1
(43) Pub. Date: Feb. 15, 2007

(54) Display servers and systems and methods of graphical display

(76) Inventors: Richard Faist Challen, Snellville, GA (US); Rick De Laet, Snellville, GA (US)

Correspondence Address: HARTMAN PATENTS PLLC, 3399 FLINT HILL PL., WOODBRIDGE, VA, 22192, US

(21) Appl. No.: 11/447,296

(22) Filed: Jun. 6, 2006

Related U.S. Application Data
(60) Provisional application No. 60/697,539, filed on Jul. 11, 2005.
(60) Provisional application No. 60/730,854, filed on Oct. 28, 2005.
(60) Provisional application No. 60/731,651, filed on Oct. 31, 2005.

(51) Int. Cl. G05B 15/00

(52) U.S. Cl. 715/734; 700/1

(57) ABSTRACT

A display server according to one embodiment includes first and second server programs that are configured to receive drawing requests from clients and to write corresponding rendering commands to respective command queues. A graphics processing unit is configured to execute the commands, to write the resulting rendered pixel data to respective portions of graphics memory, and to display pixel data from a display buffer in a selected one of the portions of graphics memory.

### RELATED APPLICATIONS

This application claims benefit of U.S. Provisional Pat. Appl. No. 60/697,539, entitled “DISPLAY SERVERS AND SYSTEMS AND METHODS OF GRAPHICAL DISPLAY,” filed Jul. 11, 2005; U.S. Provisional Pat. Appl. No. 60/730,854, entitled “DISPLAY SERVERS AND SYSTEMS AND METHODS OF GRAPHICAL DISPLAY,” filed Oct. 28, 2005; and U.S. Provisional Pat. Appl. No. 60/731,651, entitled “DISPLAY SERVERS AND SYSTEMS AND METHODS OF GRAPHICAL DISPLAY,” filed Oct. 31, 2005.

### FIELD OF THE INVENTION

This invention relates to graphical display systems.

### BACKGROUND

Graphical display systems may be used in real-time applications, such as process control or traffic management, in which a graphical display is being continually or regularly updated. It may be desired for a display system to be robust to failure.

### SUMMARY

A display server according to one embodiment includes a first server program configured to output a first plurality of rendering commands, and a second server program configured to execute as a user process separate from the first server program and to output a second plurality of rendering commands separate from the first plurality of rendering commands. The display server includes a processing unit configured (A) to output, over a first period and according to rendering commands of the first plurality, values of pixels of a first display frame and (B) to output over a second period overlapping the first period, and according to rendering commands of the second plurality, values of pixels of a second display frame.

A method of image generation according to an embodiment includes executing, within a display server, a first server program to output a first plurality of rendering commands and executing, within the display server, a second server program, as a user process separate from the first server program, to output a second plurality of rendering commands separate from the first plurality of rendering commands. The method includes executing, within the display server and over a first period, rendering commands of the first plurality on a processing unit to obtain values of pixels of a first display frame and executing, over a second: period overlapping the first period, rendering commands of the second plurality on the processing unit to obtain values of pixels of a second display frame.

A display server according to another embodiment includes a first server program configured to output, over a first period, a first plurality of rendering commands, and a second server program configured to execute as a user process separate from the first server program and to output, over a second period overlapping the first period, a second plurality of rendering commands separate from the first plurality of rendering commands. The display server includes a processing unit configured to (A) to output, according to the first plurality of rendering commands, values of pixels of a first display image and (B) to output, according to the second plurality of rendering commands, values of pixels of a second display image.

### BRIEF DESCRIPTION OF THE DRAWINGS

FIG. 1A shows a block diagram of a system including a display server 10.

FIG. 1B shows a block diagram of a system including an implementation 12 of display server 10.

FIG. 2A shows a diagram of a display server 10 in communication with multiple clients.

FIG. 2B shows a diagram of a system including multiple instances of display server 10.

FIG. 3A shows a block diagram of a dual-head implementation 10D of display server 10.

FIG. 3B shows a block diagram of a dual-head implementation 12D of display server 12.

FIG. 4A shows a block diagram of a system including redundant instances of display server 10.

FIG. 4B shows a block diagram of a system including redundant clients and redundant instances of display server 10.

FIG. 5A shows a block diagram of a system including an implementation 14 of display server 10.

FIG. 5B shows a block diagram of a system including an implementation 10D2 of display server 10D.

FIG. 5C shows a block diagram of a system including an implementation 12D2 of display server 12D.

FIG. 5D shows a block diagram of a system including an implementation 10D3 of display server 10D.

FIG. 6 shows a block diagram of a system including an implementation 18 of display server 10.

FIG. 7A shows a block diagram of a display server D100 according to an embodiment.

FIG. 7B shows a block diagram of an implementation D110 of display server D100.

FIG. 7C shows a block diagram of an implementation D120 of display server D110.

FIG. 7D shows a block diagram of a system including an implementation D130 of display server D120.

FIG. 8 shows a diagram of a system including multiple instances of display server D100 in communication with multiple clients 40.

FIG. 9 shows a diagram of a system including multiple clients in communication with server programs of multiple instances of display server D100.

FIG. 10A shows a block diagram of a network port P12.

FIG. 10B shows a block diagram of an implementation 110 of network interface 100.

FIG. 11 shows an example of an architecture for a computer system including an implementation of display server D100.

FIG. 12A shows a block diagram of an implementation G20 of graphics controller G10.

FIG. 12B shows a block diagram of an implementation G22 of graphics controller G20.

FIG. 12C shows a block diagram of an implementation G24 of graphics controller G20.

FIG. 13 shows a block diagram of an application of an implementation G30 of graphics controller G20.

FIG. 14 shows a block diagram of an implementation G32 of graphics controller G30.

FIG. 15 shows a diagram of an X server.

FIG. 16 shows a diagram of communication among elements of display server D100 via operating system 80.

FIG. 17 shows a block diagram of an implementation D140 of display server D100.

FIG. 18 shows a block diagram of an implementation M102 of display buffer M100.

FIG. 19 shows one example of different storage areas in regions allocated to different server programs.

FIG. 20 shows an example of different storage areas in which the command buffers lie outside the respective regions.

FIG. 21A shows an example of a video signal path from a selected one of two display buffers to a display device.

FIG. 21B shows an example of a dual-head video signal path including two instances of each of a display interface and a display device.

FIG. 22A shows a block diagram of an implementation 314 of processing unit 310.

FIG. 22B shows a block diagram of an implementation G40 of graphics controller G10 that includes hardware registers.

FIG. 23 shows a block diagram of a system including an implementation D200 of display server D110.

FIG. 24 shows a block diagram of a system including an implementation D210 of display server D200.

FIG. 25 shows a block diagram of a system including an implementation D220 of display server D200.

FIG. 26 shows a block diagram of a system including an implementation D230 of display server D200.

FIG. 27A shows a block diagram of a system including an implementation D240 of display server D200.

FIG. 27B shows a block diagram of a system including an implementation D250 of display server D200.

FIG. 28A shows an example of a sequence of communications among a client 40, a server program 200, and operating system 80.

FIG. 28B shows a block diagram of a resource manager RM10 in monitoring relationship with a server program 200 via operating system 80.

FIG. 28C shows a block diagram of a program manager PM10 in monitoring relationship with a server program 200 via operating system 80.

FIG. 29A shows an example of a virtual path of an input event via a kernel driver.

FIG. 29B shows an example of a virtual path of an input event via a console driver.

FIG. 30 shows a block diagram of a display server D300 according to an embodiment.

FIG. 31A shows an example of a socket driver supporting communication between two user processes.

FIG. 31B shows an example of a virtual path configured to carry information from an input device 50 to primary and secondary server programs.

FIG. 32 shows an example of an installation including an implementation D310 of display server D300.

FIG. 33 shows a block diagram of an implementation D220 of display server D200.

FIG. 34 shows a block diagram of an implementation D230 of display server D220.

FIG. 35 shows an example of a virtual path configured to carry input information from an input device 50 to server programs 200a,b via input manager 500.

FIG. 36 shows a diagram of communication among elements of display server D160 via an operating system.

FIG. 37 shows a block diagram of a display server D400 according to an embodiment.

FIG. 38 shows a flowchart of a method M100 according to an embodiment.

FIG. 39 shows two views of an Isona™ display station (BarcoView, Kortrijk, Belgium and Duluth, Ga.).

### DETAILED DESCRIPTION

The term “program” is used herein to mean one or more sets (e.g. sequences) of instructions executable by one or more arrays of logic elements, such as transistors and/or gates. During execution, a program may be embodied as one or more processes and/or threads which may communicate with hardware devices and/or with other processes and/or threads. Examples of programs include client programs (also called “client applications”) and server programs. Examples of arrays of logic elements include single-core and multicore processors, such as microprocessors and digital signal processing units, graphics processing units, and embedded controllers. Other examples of arrays of logic elements include integrated circuits (such as application-specific integrated circuits (ASICs) and application-specific standard products (ASSPs)) having one or more IP cores, and programmable arrays (such as field-programmable gate arrays (FPGAs)) having one or more IP cores.

Unless expressly limited by its context, the term “signal” is used to indicate any of its ordinary meanings, including a state of a memory location (or set of memory locations) as expressed on a wire, bus, or other transmission medium.

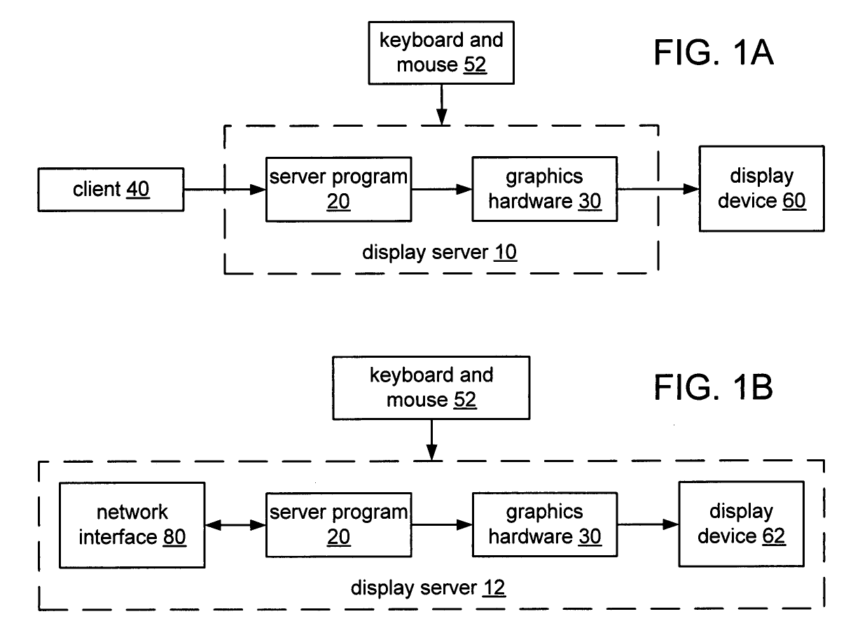

FIG. 1A shows a block diagram of a computer system that includes a display server 10 and a display device 60. Display server 10 is configured to execute a server program 20 that receives drawing requests (e.g. from a client program 40, also called a “client”) and outputs corresponding pixel-level graphics information. Display server 10 may include a processor (such as a microprocessor) configured to execute server program 20. Without limitation, server program 20 may be an application configured to run on an operating system such as Linux or another flavor of UNIX. The Visona™ display station (BarcoView, Kortrijk, Belgium and Duluth, Ga.) is one superior example of such a display server that is configured as a 2U 19-inch rack mount unit having a depth of 19 inches.

Display server 10 includes graphics hardware 30 that is configured to receive the graphics information and to output a corresponding video signal to display device 60. Graphics hardware 30 may be implemented as an expansion card configured to plug into a bus of display server 10 (such as a ISA, VESA, VME, PCI, PCI Express, or AGP bus) or as an integrated chipset (such as a chipset affixed to a system board). Display device 60 may be a cathode-ray tube (CRT) monitor; a flat-panel display such as a liquid-crystal display (LCD) panel, plasma display panel (PDP), or light-emitting diode (LED) panel; or a projection display including at least one spatial light modulator such as an LCD panel or digital micromirror device (DMD). Display server 10 may be implemented as a workstation, such as a terminal or personal computer. In an alternative configuration of display server 10, a processor executing server program 20 is implemented in an enclosure (for example, in a terminal) that is separate from a computer or other device that includes graphics hardware 30.

Display server 10 is also configured to receive input information from one or more input devices 50, such as a keyboard and/or mouse. The input device data may be handled initially by a device driver and provided to the server program via an operating system of the display server (e.g. a version of Unix or Linux, Microsoft Windows, or MacOS). At least some of the input information may indicate position data in an input space. For example, server program 20 may be configured to receive information regarding movement of a pointing device (such as a mouse or trackball, a glove, or a pen on a digitizer pad or tablet) and to output a corresponding pixel position in the display plane. In the examples herein, keyboard and mouse 52 are indicated for ease of description, but it is expressly contemplated that any input device or devices that provide a human-machine interface for interacting with the application being displayed may be used, such as a microphone (for voice recognition) and/or camera (for gesture recognition).

In the system of FIG. 1A, server program 20 is configured to receive drawing requests from a client program 40. During execution, client 40 may be implemented as one or more processes or threads executing on one or more arrays of logic elements, possibly on the same array or arrays as server program 20. In a typical system, client 40 executes on another machine, such as an application server. In this case, the other machine may also be referred to as the “client.” Other arrangements are contemplated, however, in which all or part of client 40 executes on a processor of display server 10.

Client 40 is configured to communicate with server program 20 over a bus or network, such as a local area network (LAN), using one or more protocols. Such communications may be conducted via an operating system of display server 10. The connection may be encrypted and/or requests from client 40 may be serviced only after successful execution of an authorization procedure such as verifying a “magic cookie.” Server program 20 may also be configured to send replies and/or events, such as user input or status updates, to client 40.

Server program 20 may be configured to receive drawing requests that define graphics primitives at a high level and to output corresponding pixel-level or bitmap descriptions in the form of data and/or commands that are executable by graphics hardware G30. In one example, server program 20 is an X server, such that communications between client 40 and server program 20 conform to at least one version (such as X11R6 or X11R6.6) of the X Window System Protocol (X.Org Foundation LLC, Brookline, Mass. and Delaware: www.x.org).

Like a print server, a server program such as an X server provides access to certain hardware components so that remote clients (such as programs and applications) can share access to the hardware, with access being potentially provided to more than one application at a time. In the example of FIG. 1A, server program 20 provides access to graphics hardware 30 and ultimately to display device 60. At a work position or “seat,” an operator may have one or more display devices (or “screens”) and a keyboard and mouse to manipulate and/or interact with the display, with drawing requests and input information being exchanged between the client and server. Similar schemes are used in other input and display control systems such as Microsoft Windows 98, 2000, XP, and Vista (Microsoft Corp., Redmond, Wash.).

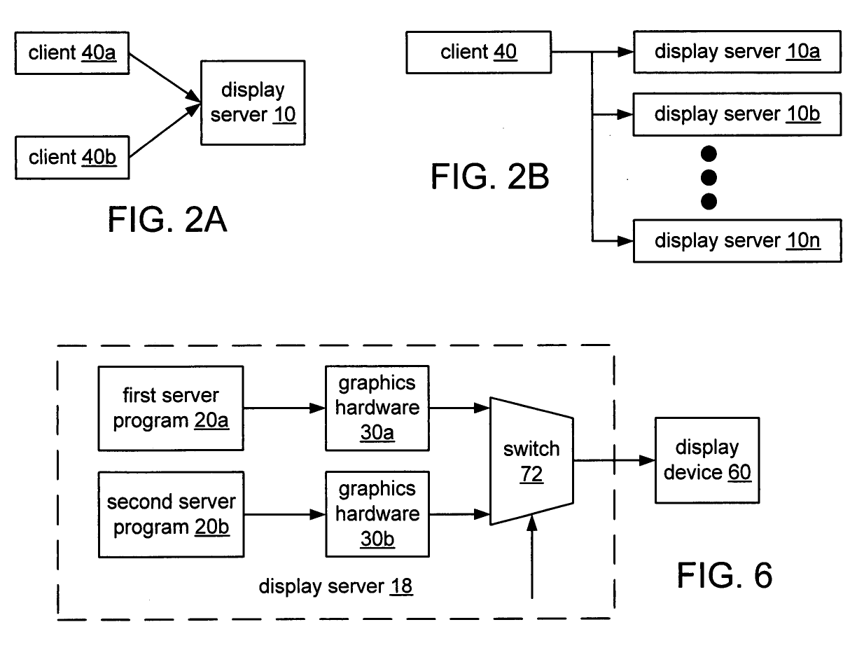

As shown in FIG. 2A, server program 20 may be implemented to receive drawing requests from more than one client. In this example, client 40b may be another application executing within display server 10, an application executing on the same computer as client 40a, or an application executing on another computer. Information from the clients may be displayed on display server 60 in different windows or otherwise as selected by the operator. Server program 20 may also be configured to transmit input information (e.g. from a keyboard or mouse) to one or more of the clients 40.

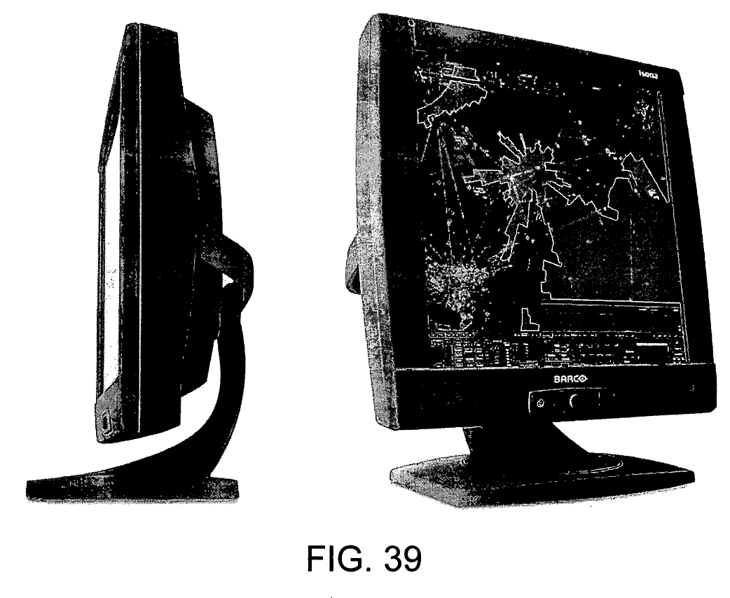

FIG. 1B shows a block diagram of a system that includes an implementation 12 of display server 10. Display server 12 has a network interface 80 (e.g. a 10/100/1000 BaseT port that may include a physical connection point such as an RJ-45 socket) and a display device 62 (for example, a CRT or LCD panel) integrated into the same enclosure as the other components of the display server. FIG. 39 shows two views of the Isona™ display station (BarcoView, Kortrijk, Belgium and Duluth, Ga.), one superior example of such a display server that has an active screen diagonal of twenty-eight inches and an active screen resolution of 2048×2048 pixels. As opposed to a display monitor having only a video interface, a display station of this type is a network appliance, like a printer, which may be connected to a network (via an RJ-45 socket, for example) and which multiple applications can access.

It may be desired for the same client to provide drawing requests to more than one work position. FIG. 2B shows a block diagram of an arrangement in which multiple instances of display server 10 receive drawing requests from a client 40. Such an arrangement may be used in applications such as education, industrial process control, or traffic control (for example, air traffic control). Client 40 may issue each drawing request only once and/or may direct a different copy of each request to each instance of display server 10. Each instance of display server 10 (or “work position” or “seat”) may be equipped with its own set of input and output devices 50 and 60.

In some applications, the amount of data to be viewed at one time may be greater than the amount of real estate available on the display. For example, the amount of data to be displayed may exceed the ability of a single display screen to intelligibly convey that information to the operator at one time. Although operations could be done to allow viewing of all of the data, such as providing the operator with the ability to switch between multiple windows and/or to pan the visible window across a larger virtual display window, still such operations would not allow all of the data to be seen at any one time. In such cases, more than one display device 60 may be used at a work position. For example, a seat in an air traffic application may include one large display that shows the changing positions of the aircraft being tracked, and another display (possibly of lower resolution) that shows text-oriented data such as flight strip and/or weather information. In some cases, it may even be desirable for a work position to have three or more displays.

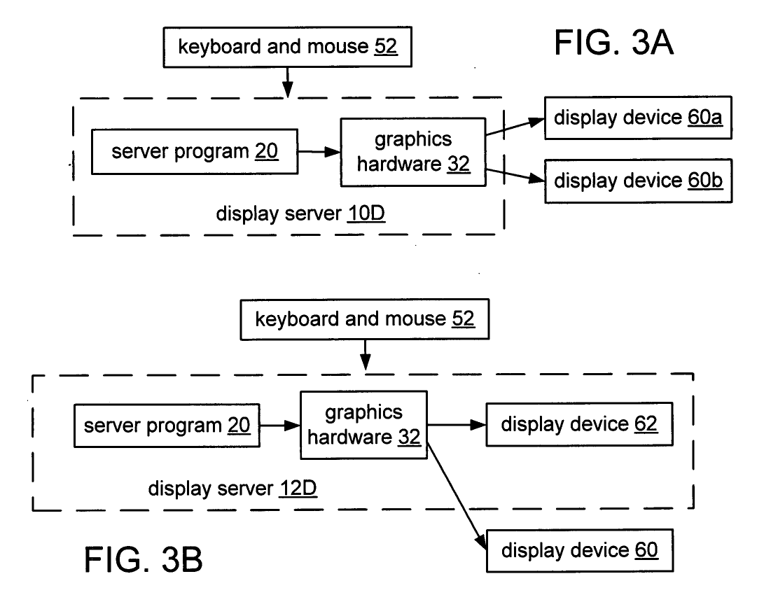

Graphics hardware supporting dual-head displays is commonly available. For example, such hardware may be obtained in the form of an expansion card or integrated chipset having two display outputs (e.g. SVGA and/or DVI), each capable of providing a different image from the other. FIG. 3A shows an example of a system including an implementation 10D of display server 10, where display server 10D includes an implementation 32 of graphics hardware 30 having dual-head capability. FIG. 3B shows an example of a system including a dual-head implementation 12D of display server 12 that has an integrated display device 62. The Isona™ display station is one example of a superior display server that supports connection to a low-resolution display device for dual-head display.

It may be desirable to provide redundancy of hardware at a seat, such that the operator may continue to perform her task even after a hardware glitch or failure. Historically, the mean time between failures (MTBF) for the graphics hardware and workstation executing the server program were much lower than the MTBF for the display device, such that it was desirable to extend the uptime period of a work position by duplicating the graphics hardware and workstation.

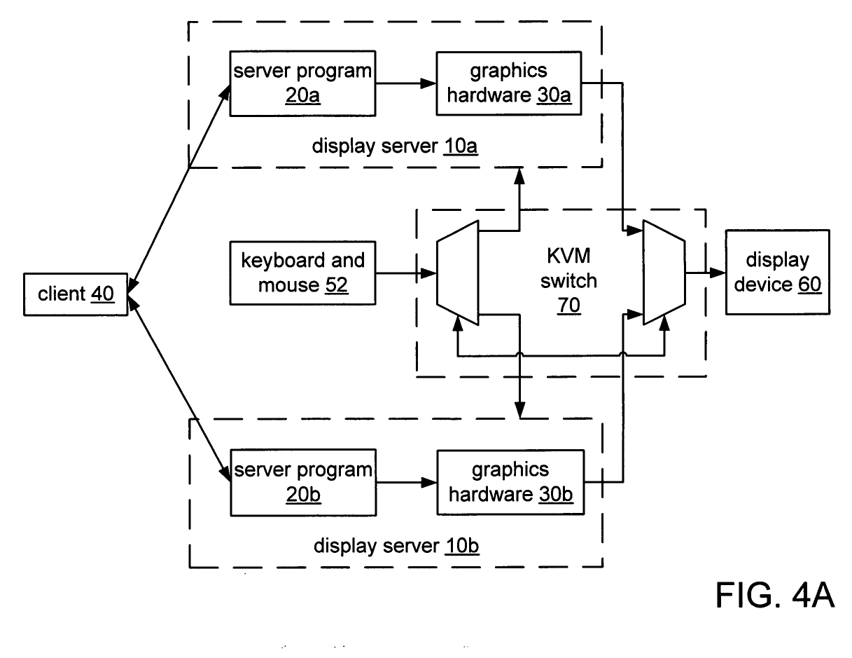

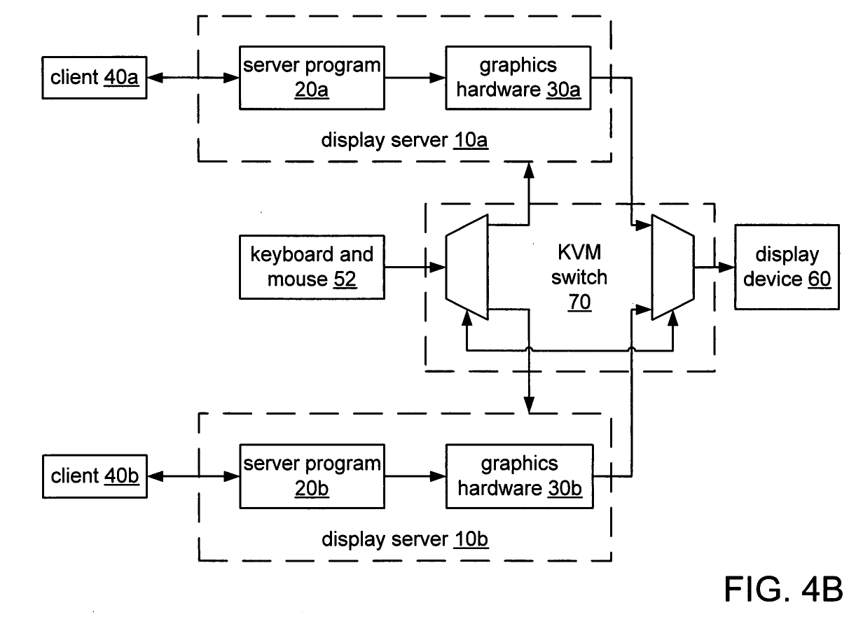

FIG. 4A shows an example of a redundant arrangement that includes multiple instances 10a, 10b of display server 10. In this example, both instances of display server 10 receive drawing requests from client 40. Client 40 may issue each drawing request only once or may direct a different copy of each request to each server program 20. The video output to display device 60 is switchable from one display server to the other via keyboard-video-mouse (KVM) switch 70 such that the output of one display server is visible at a time. The KVM switch 70 is also arranged to switch information from input devices 52 to the display server which is currently visible. In an alternative arrangement, both display servers receive the input information. During one mode of use, both instances of display server 10 are active such that the operator may switch quickly the display from one to the other. In case of failure of the visible display server, for example, the other display server may be switched in with minimal interruption. KVM switch 70 may perform the switchover mechanically (e.g. by rotation of a set of switch contacts from one detent to another) or electrically (e.g. by changing the electrical states of a set of analog switches according to a position of a pushbutton switch).

A redundant architecture may be desirable for several practical reasons. In air traffic control, for example, uptime is an important concern, and it is desirable for the system to remain operational for well over 99.99% of the time. Thus a typical installation will include spare seats. An operational center specified to have forty active seats, for example, may actually have a total of forty-five or fifty operating display servers. If one seat goes down, it is desirable for the operator to be able to move to another seat, type in her passkey or perform a similar identification or authentication procedure, and view the same image as from the seat that went down. In case of other failures, the system may also include redundancy in other elements such as the power plant, a physical network and/or data feed, a data acquisition or monitoring system such as a radar installation, and so on. In some applications such as airliner avionics, triple redundancy (10ˆ−9% expected downtime, vs. 10ˆ−6% expected downtime for double redundancy) may be required.

In life-critical and/or mission-critical environments that include complex and custom software, a fallback application may be needed more because of the risk of software malfunction than for the risk of a hardware malfunction. It is possible for a client program 40 to contain an undetected bug, such as a race condition or a bug that is related to load. In such case, a client 40 may crash, lock up, or otherwise fail when a particular load condition is met during use. In an air traffic control application, for example, a failure may occur when some large number of tracks becomes present in the database for the area of interest. A failure of client 40 may affect every seat in the system that is communicating with the client.

In one historical example, several years ago a major air traffic enroute center was affected by a client failure. After the center had been operational for several months, a software upgrade was performed. A few hours later, as the system load began to increase, the system began to slow and finally halted. During the several hours it took to reload the previous software, air traffic over a large geographical region was halted.

Especially in the US, a backup system is required in an air traffic installation. Typically the server hardware is duplicated at each seat, with each duplicate serving a different client, and with the input and display being switchable between different clients. The clients may be written by different companies and may also have a different screen appearance from one another (for example, to alert the operator when a change in visibility from one client to another has occurred). In some cases, the backup client is the application that was used as the primary client before an upgrade to the current primary client. It may be desirable (or even required, as by Federal Aviation Administration (FAA) regulation) that the backup (or “fallback”) application be completely different software, e.g. to protect against replication of a software error. For added reliability, the system may also include other redundancies such as two different physical networks. An air traffic installation may even include a backup radar feed.

FIG. 4B shows one example of an arrangement that includes multiple instances of display server 10 supporting one seat, each instance configured to receive drawing requests from a different client, and a KVM switch 70 configured to switch between the video signals of the display servers. Such an arrangement allows the operator to share a display device 60 (and input devices 52) among more than one client and to switch the display from one client to another. Such an arrangement may be used to provide redundancy in both hardware and software at the display server, and it may also be used to provide redundancy at the client level. Even if a client crashes or a display server fails, the operator can access and/or interact with another client and server system without moving to another seat.

Today, the MTBF for computer hardware is relatively high. It may be desirable to leverage such reliability to reduce hardware duplication at each seat. For example, it may be desirable to exploit available hardware capacity (e.g. processor cycles) to support client redundancy with a single display server. The MTBF for the graphics hardware in a modern system may also be high as compared to other devices in the system, and it may be desired to use one instance of graphics hardware 30 to process display information from more than one client.

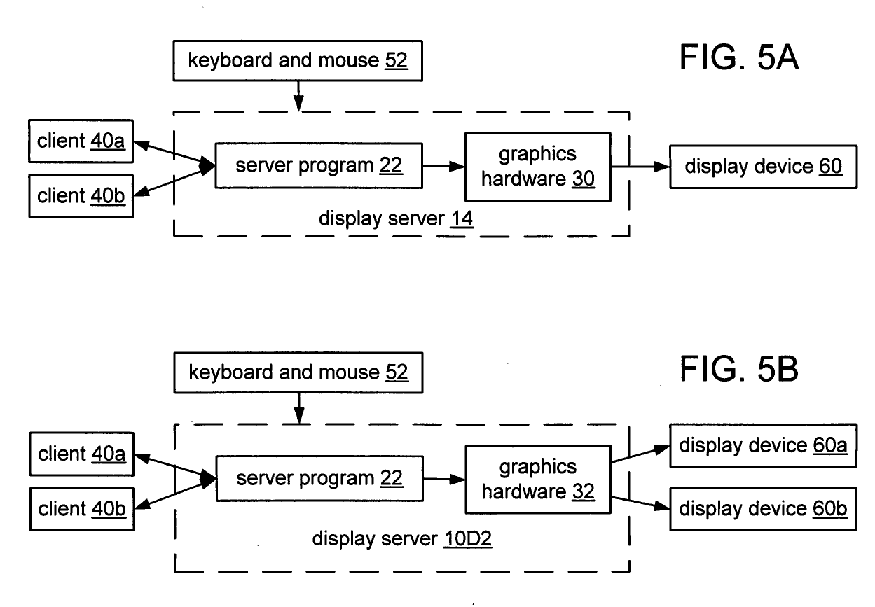

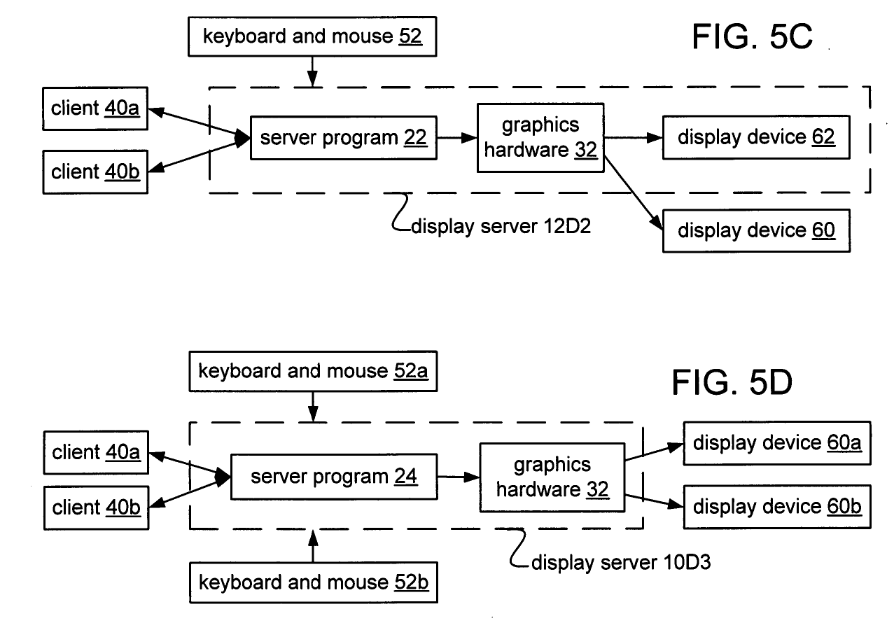

FIG. 5A shows a block diagram of a system including an implementation 14 of display server 10. Display server 14 includes an implementation 22 of server program 20 that is arranged to service drawing requests from multiple clients 40. The resulting images from each client may be displayed in different windows of the display, or the display server may be configured to switch the display between images from the different clients as indicated, for example, by the operator. FIG. 5B shows a block diagram of a similar system that includes a dual-head implementation 10D2 of display server 10D.

It may also be desirable to support client redundancy using an integrated display device in which the video input of the display device is not accessible for switching via a KVM switch. A display station having an integrated display (such as the Isona™, for example) may lack a direct access to the display input, such that mechanical switching among more than one video signal is not available. FIG. 5C shows a block diagram of a system including an implementation 12D2 of display server 12D. Display server 12D2 includes an integrated display device 62 and also supports a second display device 60 (e.g. via an analog or digital video connection). For example, display device 62 may be a high-resolution display, and a lower-resolution signal may be output to display device 60. The two video signals may correspond to the same client or to different clients.

It may even be desired to use a single display server to support more than one seat. FIG. 5D shows a block diagram of a system including an implementation 10D3 of display server 10D. In this example, an implementation 24 of server program 20 services drawing requests from two clients at the same time. The system also includes a separate set of input devices 52 corresponding to each client, with each set corresponding to a different seat and being controlled by a different operator. In this case, the dual-head capability of graphics hardware 32 may be used to support a different display device 60 for each operator, each device displaying an image that corresponds to the respective client, such that each client is visible at the same time.

In comparison to the MTBF of the system hardware, software vulnerability may be higher today than previously. For example, a client application and/or a combined client-server software subsystem may have a lower MTBF relative to the hardware than in previous generations. One or both of the client 40 and server program 20 may fail due to an internal flaw (for example, a race condition or a load-related fault) that appears only after deployment. Moreover, their combination may also be vulnerable to failure, such as one of the clients causing the server program, the operating system, and/or some other software component of the display server to crash.

A client application that repeatedly asks for memory or other resources (e.g. from a limited set of identified resources such as color IDs), without deallocating or deassigning the resources no longer in active use, may cause the server program to run out of one or more resources and stall or crash. A software failure may also be triggered by a particular interaction of the server program with the server's operating system and/or with one or more clients. Even though a system as shown in FIGS. 5A-D may be used to support client redundancy, server program 20 represents a single point of failure in each of these systems.

FIG. 6 shows a block diagram of a system that includes an implementation 18 of display server 10. Display server 18 has two instances 20a,b of server program 20, which may execute on the same processor and/or under the same operating system. Each server program 20 sends pixel-level information to a respective instance of graphics hardware 30. The resulting video signal of a selected instance of graphics hardware 30 is output to display device 60.

The selection as to which video signal is visible may be performed by an operator of display server 18 via a video signal switch 72, which may be implemented as part of a KVM switch. Switch 72 may be configured to implement the operator's selection by disabling the unselected display output, for example, or by connecting the selected display output to a video signal line. The operator's selection may be entered into switch 72 mechanically (e.g. as a switch position) or electrically (e.g. in response to keyboard entry of a hot-key combination). In a further implementation of display server 18, one or both instances 30a,b of graphics hardware 30 has dual-head capability.

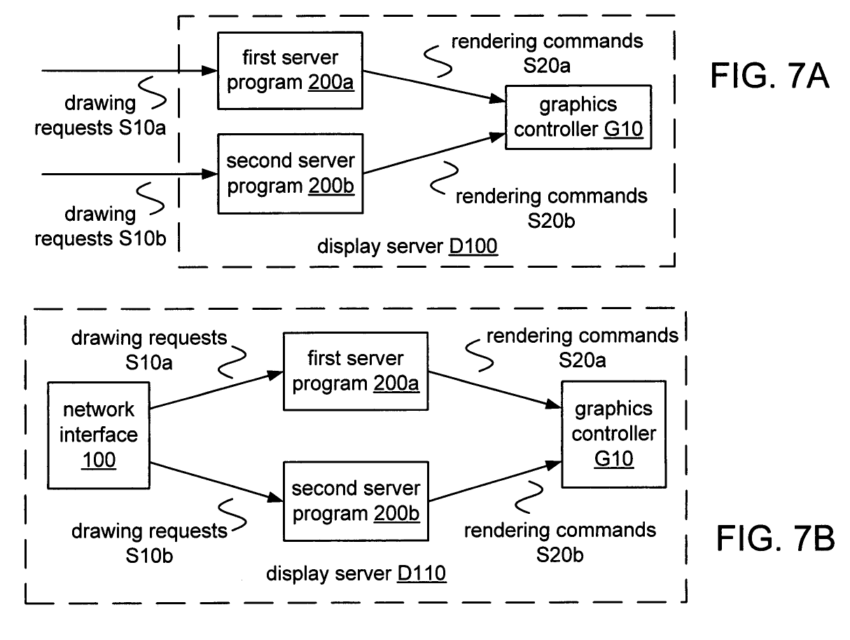

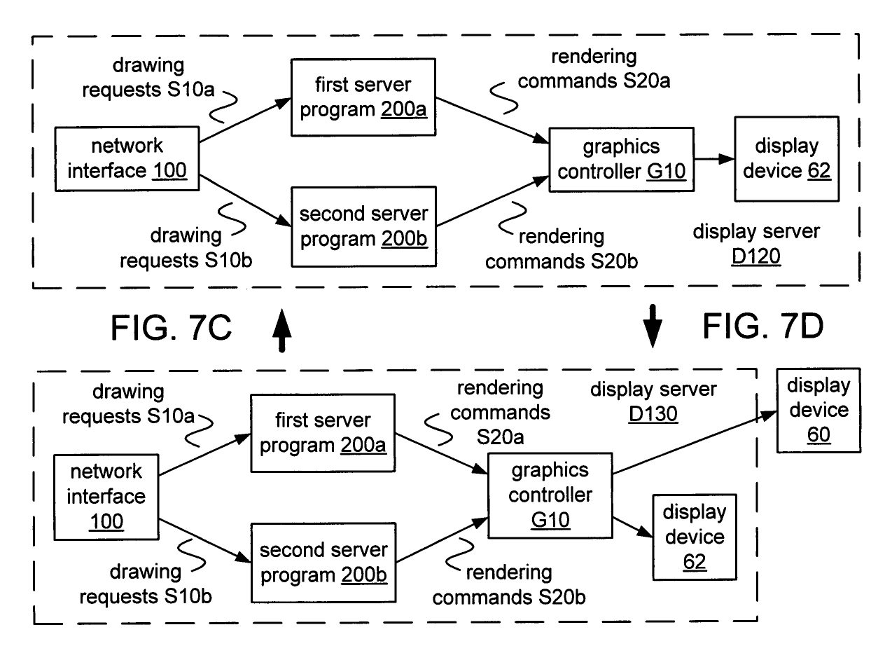

It may be desirable to use a new display server architecture, in which multiple embedded server programs share the same graphics hardware. FIG. 7A shows a block diagram of a display server D100 according to an embodiment that includes two instances 200a,b of a server program 200. Each of these instances of server program 200 is configured to receive a corresponding set of drawing requests S10 that relates to a respective image. Typically, each of the instances of server program 200 is configured to receive a corresponding stream of drawing requests S10 that relates to a respective sequence of images, such as respective frames of an animated representation. Drawing requests S10a and/or S10b may be generated locally: for example, by one or more clients executing on a processor of display server D100. Alternatively, drawing requests S10a and/or S10b may be received from one or more clients over one or more networks. The stream of drawing requests need not be synchronous or continuous, and in some cases a server program may receive no drawing requests for a long period of time (e.g. tens of minutes). In response to the drawing requests S10, each instance of server program 200 is configured to output rendering commands S20 to a graphics controller G10.

In a typical application, graphics controller G10 is configured to output a video signal corresponding to a selected one among the two images (or to a selected one among the two image sequences). For example, the operator may select between a video signal corresponding to a primary client, as managed by server program 200a, and a video signal corresponding to a backup or secondary client, as managed by server program 200b.

To support the operator's selection of which server program 200 (that is to say, which image or sequence) is to be visible, display server D100 may be implemented to include any mechanism suitable for the particular application. A position of a mechanical switch may indicate the selection. Alternatively, an input event such as a mouse click at a particular screen location, or a keyboard action such as a “hot key” (possibly a multi-key combination similar to the Ctrl-Shift-Del or Ctrl-Alt-Del combination for reboot), may indicate the selection. An implementation of display server D100 may also be configured to support external selection of server program visibility: by a client, for example, or by a remote operator or supervisor.

As described in further detail below, graphics controller G10 may be configured to render pixel values corresponding to the different sets or streams of rendering commands S20a,b into different corresponding display buffers. While both clients continue to direct the respective server programs to draw to their display buffers, and while both server programs actively update their corresponding images, the operator only sees and interacts with the client or clients of the visible server program. The display buffer corresponding to the selected image or sequence is directed to the screen, such that the operator only sees the output of one server program or the other. Input information may also be logically directed to interact with the appropriate (e.g. the visible) server program and/or client.

The different instances 200a,b of server program 200 may be configured to communicate regarding input events and/or system status such as resource usage. Alternatively, server programs 200a,b may be configured to execute completely independently of one another. Likewise, the dual nature of display server D100 may be completely transparent to the clients, which need not be aware that they are sharing graphics hardware or that more than one server program is executing. For example, display server D100 may be implemented such that the operations of sharing the graphics controller G10 and switching the display from one client to another are completely invisible to the client programs. Characteristics of the graphics hardware (such as whether the depth is 8, or 16, or 24 bits, and whether color tables are used or not) may also be hidden from the clients, and display server D100 may be implemented such that the clients need not be aware of any restrictions on the values of such attributes.

In a typical implementation of display server D100, server programs 200a,b appear externally as different servers having separate communications paths. In such case, the output of each server program may be separately recorded (e.g. for archival purposes).

Display server D100, which may be implemented as a Visona™ or Isona™ display station running software as described herein, represents a new architecture that may be used to replace a system that currently requires mechanical switches and duplicative hardware. In a typical upgrade of this kind, the conventional mode of using external KVM switches to select among video signals from different display servers is replaced with multiple server programs executing within one display server. The capabilities of graphics processing chips have progressed tremendously in recent years to rival or even exceed those of the CPU of the host computer, and display server D100 may also be implemented to exploit such hardware features.

An installation may include more than one instance of display server D100, with several or even all of those instances receiving drawing requests from the same client or clients. FIG. 2B shows one example of such a model, in which each instance of display server D100 may be used to support a different work position. Communications between the client and server programs may be conducted over a local area network (LAN) and may include drawing requests and input device information (e.g. as received from a keyboard and mouse). Such communications may also include a command for display server D100 to switch the display from one server program 200 to the other. In some cases, a server program 200 may receive drawing requests from a client program executing on one machine (an application server) and associated data from a client program executing on another machine (a data server).

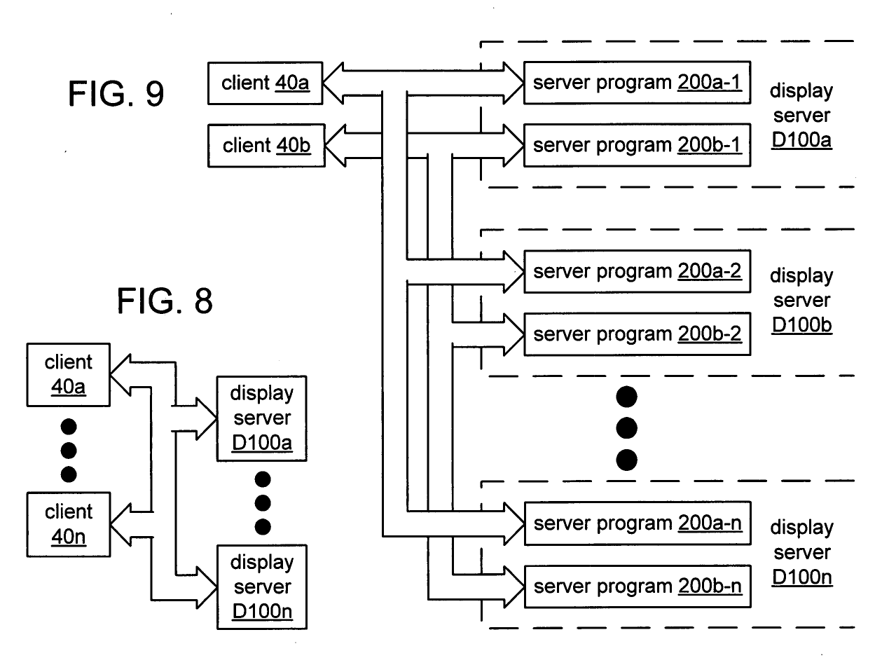

As shown in FIG. 8, multiple instances of display server D100 may be arranged to receive drawing requests from one or more clients. These instances of display server D100 may be configured to receive drawing requests over a network such as an Ethernet network. FIG. 9 shows a diagram of an installation in which the server programs 200a,b of each instance of display server D100 communicate with different respective clients 40a,b. Communications with different clients may be conducted over the same network or over different respective networks. Connection over different networks may provide additional redundancy against failure (e.g. breakage) of a physical transmission medium. In such case, display server D100 may include more than one network port (and, for example, more than one RJ-45 socket or other network connector).

FIG. 7B shows a block diagram of an implementation D110 of display server D100 that is configured to receive drawing requests S10a,b (possibly from different respective clients 40a,b) from a source external to the display server via a network interface 100. The network may be a wired network such as Ethernet over coax or twisted pair, a wireless network such as a wireless LAN, a network over another medium such as optical fiber, or a network over a combination of such media. Communication over the network may occur via any network protocol, such as TCP/IP or DecNET, that is deemed suitable for the application and/or medium. Communication via network interface 100 may also be compliant with one or more of the set of IEEE 802 standards (such as Ethernet or Gigabit Ethernet).

FIG. 7C shows a block diagram of an implementation D120 of display server D110 that includes an integrated display device 62. FIG. 7D shows a block diagram of an implementation D130 of display server D120 that also supports a second display device 60 (e.g. via an analog or digital video connection). For example, display device 62 may be a high-resolution display, and a lower-resolution signal may be output to display device 60. The two video signals produced by such an implementation of graphics controller G10 may correspond to the same client or to different clients.

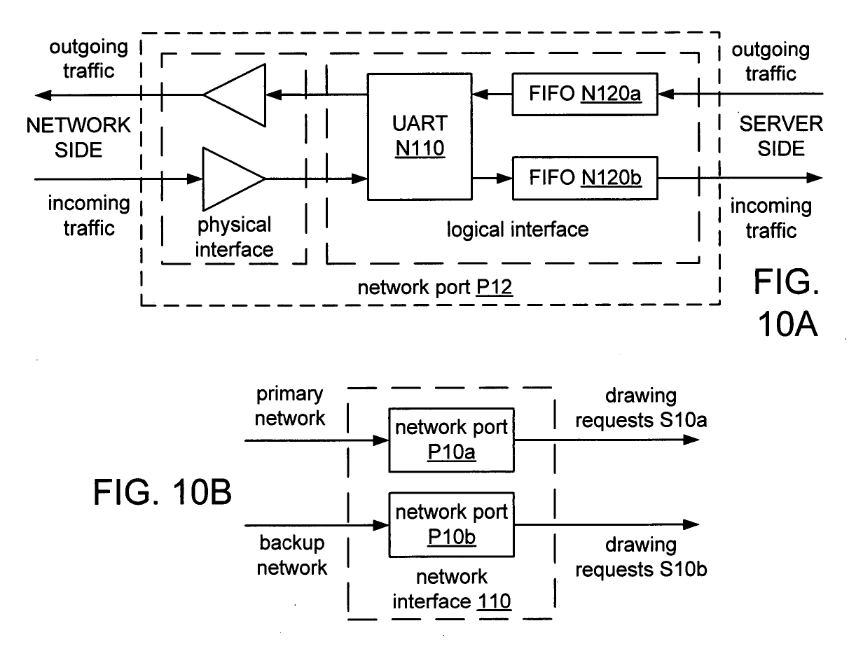

Network interface 100 may include a network port (e.g. a 10/100/1000 BaseT port) that carries drawing requests from more than one client 40 and/or for more than one server program 200. For example, network interface 100 may be implemented as a network port according to the implementation P12 shown in FIG. 10A. Network port P12 includes a logical interface configured to convert data between serial and parallel forms. In a typical application, communication with the network is conducted in a serial fashion, via a device such as a universal asynchronous receiver/transmitter (UART), while data is exchanged with other elements of the display server in parallel (e.g. in bytes). Network port P12 also includes a physical interface to the network medium. The physical interface may include devices such as serial line drivers and/or impedance-matching components. Depending on the transmission medium, the physical interface of a network port may also include devices to perform conversion to and/or from radio-frequency or light (for example, modulation and/or demodulation of one or more carrier frequencies), an antenna, and/or a connector such as an RJ-45 socket or fiber-optic connector.

As shown in the example of FIG. 10A, a network port may be bidirectional. For example, it may be desirable for display server D100 to receive drawing requests and also to transmit information such as input events (keyboard and/or mouse input) to one or more clients. Network port P12 may be implemented as a network interface card, such as an expansion card configured to plug into a bus such as a PCI, PCI Express, AMR, VME, ISA, PC-104, or other standard or modified bus.

Alternatively, network interface 100 may include more than one port. In an application where the network includes a physical medium such as wire or optical fiber, for example, it may be desired to deploy two or more separate (e.g. redundant) networks. In such an installation, communications may continue over one network even if the medium of another network fails (e.g., a network cable breaks or is cut). FIG. 10B shows a block diagram of an implementation 110 of network interface 100 that includes two network ports P10a and P10b, one or both of which may be implemented according to the bidirectional example P12 of FIG. 10A. Each such port of the network interface may be implemented as separate hardware, such as separate expansion cards. Alternatively, the ports may be implemented to operate as separate logical entities that share hardware such as a chipset or UART.

In a typical application of a personal computer, nearly all significant screen display is initiated by the operator via a keyboard and mouse. In contrast, a display server used in an air traffic control application receives significant continuous input from other sources (e.g. clients 40). For example, such a server may be configured to display a large number of maps and targets in real time without any additional action by the operator. This display is usually updated at least several times a second. In an air traffic control context, for example, a screen image that represents the current positions of moving aircraft is typically redrawn (e.g. by a client 40) at a rate in the range of from one to ten times per second. This refresh rate, which may be synchronous or asynchronous, is usually less than or equal to than the frame rate of the corresponding video signal (which is typically in the range of 60 to 85 Hertz).

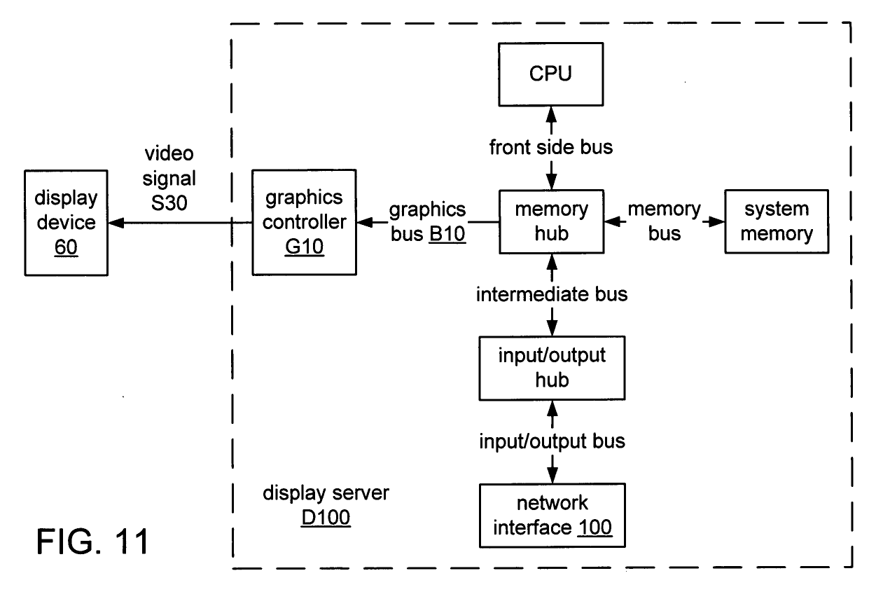

FIG. 11 shows an example of the hardware system architecture for a typical implementation of display server D100. It is expressly noted that this hardware architecture also encompasses most implementations of display server D10. As shown in FIG. 11, this implementation includes a central processing unit (CPU) configured to execute the server programs 200a,b. The CPU may be implemented as a single-core or multicore processor (as manufactured by, for example, Intel, IBM, Advanced Micro Devices (AMD), or Sun Microsystems) and may also be configured to execute other programs such as an operating system of display server D100. In another example, the CPU includes two or more processors sharing a common operating system and system memory. Other embodiments include arrangements in which the CPU is an embedded processor, such as an IP core (as designed by, for example, ARM or MIPS) programmed into an array such as a field-programmable gate array (FPGA).

The CPU as shown in FIG. 11 is configured to communicate with a memory hub over a high-speed front side bus (FSB). Common terms for various implementations of the memory hub include a Northbridge, a graphics and memory controller hub (GMCH), a system controller, and a system platform processor (SPP). In a typical implementation, the memory hub communicates with the system memory over a standard memory bus interface such as double data rate (DDR), DDR2, or RDRAM (Rambus).

The memory hub as shown in FIG. 11 also communicates with an input/output hub over an intermediate bus. Examples of technologies that may be used to implement the intermediate bus include HyperTransport™ (AMD), VLink™ (Via), and Hub Link (Intel). Common terms for various implementations of the input/output hub include a Southbridge, a peripheral bus controller, an input/output controller hub (ICH), and a media and communications processor (MCP). The input/output hub communicates with devices such as a network interface via an input/output bus such as PCI, PCI Express (PCI Special Interest Group, Portland, Oreg.), or VME. Other devices that may be connected to the input/output bus include magnetic and/or optical disk storage; removable storage (such as a USB or Firewire device); and an authentication unit such as a removable key device, a fingerprint or other biometric reader, or another type of access control device such as a keypad or card reader.

In this example, a graphics bus B10 carries communications between the memory hub and the graphics controller G10. Graphics bus B10 may conform to a specification such as a version (e.g. 1×, 2×, 4×, 8×, and/or Pro) of Accelerated Graphics Port (AGP) or a version of PCI Express. Graphics controller G10 may be implemented as an expansion card configured to plug into a bus of display server D100 (such as an ISA, VESA, VME, PCI, PCI Express, or AGP bus), as an integrated chip or chipset that is affixed to a system board, and/or as a device that is incorporated into another chip or chipset, such as a Northbridge, Southbridge, or CPU. In some cases, for example, the memory hub is implemented as an integrated graphics processor (IGP) that includes a graphics processing unit (GPU).

Graphics controller G10 includes a processing unit 310 configured to execute rendering commands S20a,b and to output corresponding rendered pixel values. For example, processing unit 310 may be configured to store the rendered pixel values to display buffers in local or system memory. Processing unit 310 may be a graphics processing unit (GPU) as manufactured by 3Dlabs, Nvidia, or ATI or another SIMD or vector processing unit. Some GPUs may also be referred to as visual processing units (VPUs). In one implementation, graphics controller G10 includes a P20 GPU (3DLabs, Milpitas, Calif.). Display server D100 may be implemented for virtually any current or future GPU instruction set, GPU architecture, and/or graphics card or subsystem architecture (e.g. AGP or PCI-Express expansion card).

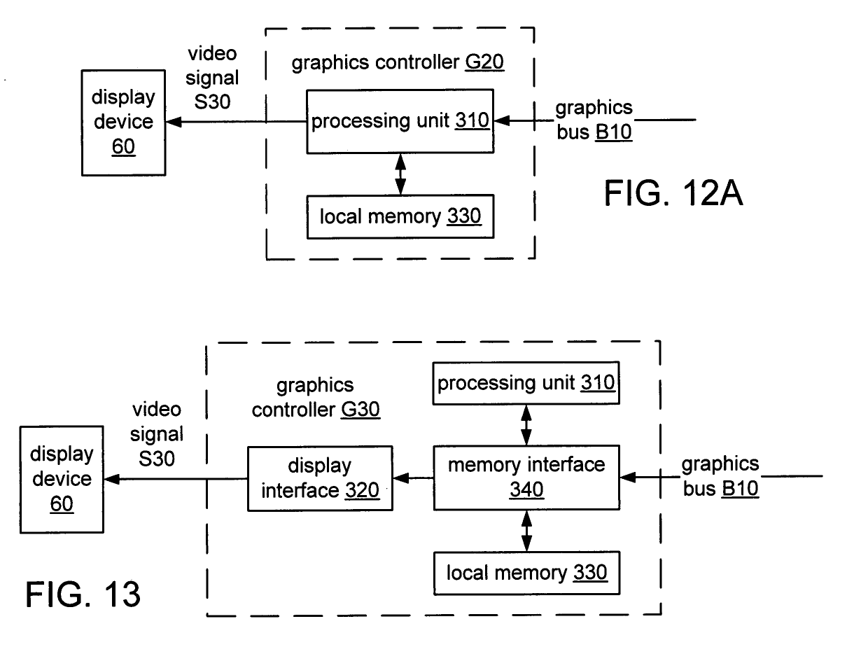

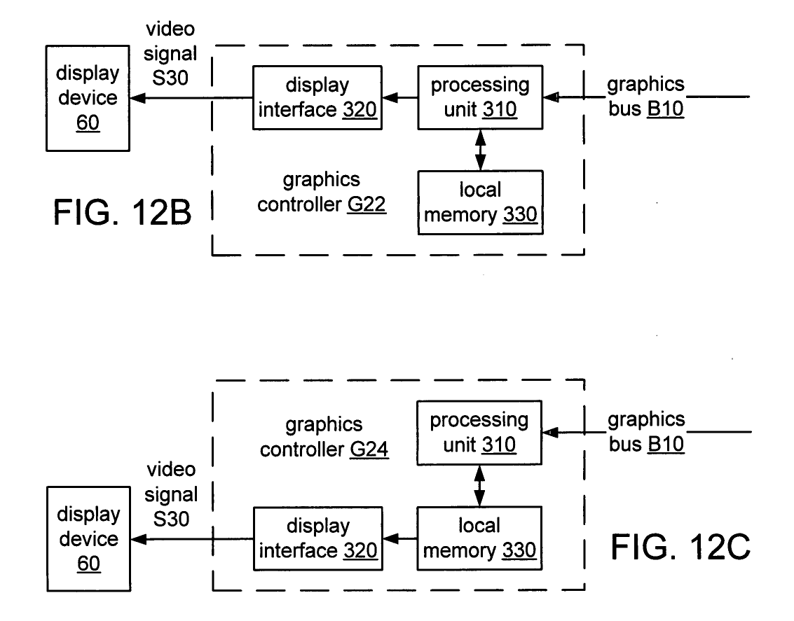

FIG. 12A shows a block diagram of implementation G20 of graphics controller G10 that includes a local memory 330. As used herein, the term “local memory” refers to memory that meets at least one of these two criteria: (A) memory that is integrated within a chip or chipset of graphics controller G20 and/or is onboard an implementation of graphics controller G10 that is separate and removable from a mainboard of display server D100 (e.g. an expansion card) and (B) memory that is directly addressable only within graphics controller G20 and not by the system CPU and/or any device on the other side of graphics bus B10. In a typical implementation, local memory 330 meets both criteria, although in some such cases local memory 330 may be indirectly accessible from the system side of graphics bus B10. In the example of FIG. 12A, processing unit 310 is configured to retrieve rendering commands from local memory 330 and/or to store values of rendered pixels to local memory 330. Information stored in and/or retrieved from local memory 330 may also indicate display configuration parameters such as bit depth and screen size in pixels.

FIG. 12B shows a block diagram of implementation G22 of graphics controller G20 that includes a display interface 320 configured to produce a video signal S30 based on pixel values. At a specified time (for example, according to a frame rate of video signal S30), processing unit 310 reads the rendered pixel values from a portion or portions of local memory 330 to be displayed and outputs the pixel values to display interface 320, which produces a corresponding video signal S30. Display interface 320 may produce video signal S30 at a fixed (synchronous) or variable frame rate, typically in the range of from 60 to 90 Hertz.

FIG. 12C shows a block diagram of an alternate implementation G24 of graphics controller G20 in which display interface 320 receives the pixel values from local memory 330 rather than via processing unit 310. In this example, processing unit 310 writes values of rendered pixels to local memory 330, and display interface 320 reads the pixel values from local memory 330 (for example, according to a frame rate) and produces video signal S30 based on the pixel values. In this case, display interface 320 may include scanout logic configured to scan one or more storage areas of local memory 330 such as display buffers.

Display interface 320 is configured to produce video signal S30 as a series of video frames, each video frame of the series representing a screen image scanned out from pixel value storage. As noted above, the frame rate may exceed the image refresh rate, such that display interface 320 may scan out the same screen image two or more times for consecutive video frames in the series. Video signal S30 also includes a periodic signal that indicates a frame boundary between each consecutive pair of the series of video frames. The frame boundaries define frame periods of substantially equal duration, with each video frame in the series being scanned out during a corresponding one of the frame periods.

For a case in which video signal S30 is an analog signal (e.g. a composite video signal), the periodic signal is a vertical synchronization signal which indicates the start and/or end of each frame and has a frequency equal to the frame rate of display signal S30. In this case, video signal S30 may also include a horizontal synchronization signal, which indicates the start and/or end of each line of the frame. For a case in which video signal S30 is a digital signal (e.g. a DVI-D signal), the periodic signal is a special character that appears periodically in the video signal and identifies the top of each frame (vertical synchronization signal). In this case, video signal S30 also typically includes a pixel-level clock as well as other special characters that appear periodically in the video signal and identify the bottom and the left and right sides (horizontal synchronization signal) of each video frame.

Display interface 320 may include at least one cathode-ray tube controller (CRTC) configured to produce a monochrome or color (e.g. RGB) analog video signal. Alternatively or additionally, display interface 320 may be configured to produce at least one Digital Video Interface (DVI) signal (e.g. for a flat-panel display device) and may support a single- or dual-link DVI signal. Examples of typical sizes for video signal S30 include 1024×768, 2048×2048, 2560×1600, 2560×1920, and 3480×2400 pixels. Display interface 320 may also be configured to perform operations such as digital-to-analog conversion, horizontal/vertical scan signal generation, and/or gamma correction. Display interface 320 may be included within at least some implementations of processing unit 310. Alternatively, display interface 320 may be otherwise included within a chipset of graphics controller G10 or provided separately within graphics controller G10.

FIG. 13 shows a block diagram of an implementation G30 of graphics controller G20. Controller G30 includes a memory interface 340 configured to arbitrate data transfer between local memory 330 and other elements of graphics controller G30, such as processing unit 310 and display interface 320. Memory interface 340 may also be configured to arbitrate data transfer between local memory 330 and devices on the other side of graphics bus B10, such as the CPU and/or system memory. Memory interface 340 may be configured to perform transfers to and/or from local memory 330 via direct memory access and/or may be configured to include scanout logic to provide pixel values to display interface 320.

Memory interface 340 may be included within at least some implementations of processing unit 310. For example, one or both of memory interface 340 and display interface 320 may be integrated into the same chip as processing unit 310. Alternatively, memory interface 340 may be otherwise included within a chipset of graphics controller G10. For example, memory interface 340 and display interface 320 may be integrated into the same chip of such a chipset.

Display server D100 may be configured to support a flow of rendering commands to graphics controller G10 via graphics bus B10, as indicated by the arrows in FIGS. 11-13. In at least some implementations of display server D100, graphics controller G10 is also configured to transmit information to system memory over graphics bus B10 (i.e. in the opposite direction). Such transfer may be performed using an address remapping scheme such as an aperture.

The portion of memory that is scanned out for display may be selectable. Different screen images may be rendered for one client 40 or server program 200, for example, and it may be desired to select among these images for display. In a double buffering configuration, it may be desired for the scanout operation to switch between alternate portions of a display buffer at a fixed or variable rate (e.g. upon an event such as an indication from a server program 200 or processing unit 310 that rendering of a frame to one of the portions has been completed). As described herein, graphics controller G10 may also be configured to redirect the scanout operation from one portion of memory to another according to the state of a display context signal S50, which state may correspond to a visible one of server programs 200a,b. Alternatively, graphics controller G10 may be configured such that a particular portion of memory is reserved to be scanned out, with processing unit 310 and/or memory interface 340 being configured to store the rendered pixel values of the screen image to be displayed into this portion of memory.

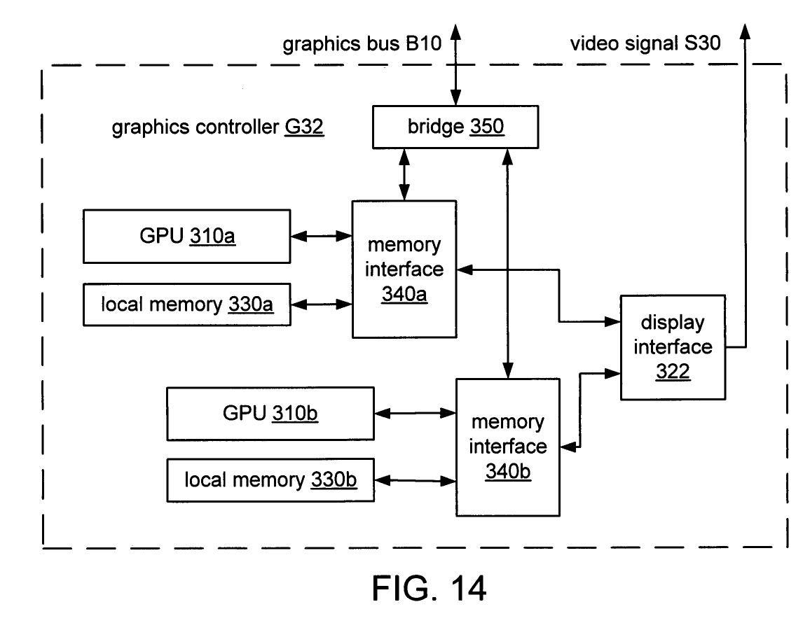

In a typical implementation of display server D100, graphics controller G10 includes one processor, such as a GPU. In some cases, graphics controller G10 may include more than one processor, possibly on the same expansion card. FIG. 14 shows a block diagram of one such implementation G32 of graphics controller G30, in which each GPU 310a,b is configured to execute a different set of rendering commands. Bridge 350 is configured to arbitrate data transfer between a local memory space of graphics controller G32 and devices on the other side of graphics bus B10, such as the CPU and/or system memory. Within the local memory space, each GPU 310 is configured to access a corresponding one of local memories 330a,b, which may be implemented as different portions of the same array of storage elements or as physically separate arrays (e.g. chips).

In the example of FIG. 14, each processor 310a,b may be dedicated to executing rendering commands from a corresponding server program 200. Alternatively, each processor 310a,b may be configured to execute rendering commands from more than one of the server programs 200. In such case, each processor may be configured to render alternate scan lines or separate sets of scan lines of each frame (also called “split frame rendering”), or to render alternate frames, or to execute rendering commands associated with different graphics primitives of the same frame. Depending upon the rendering configuration, it may be desired for implementation 322 of display interface 320 to display pixel values from one or both local memories 330 at each frame. Further embodiments of display server D100 include a graphics controller having two or more processors 310 (possibly on separate expansion cards) that share a video memory space via an interface such as Scalable Link Interface (SLI) (NVIDIA Corporation, Santa Clara, Calif.). It is expressly noted that the term “processing unit,” as it appears herein and in the claims in reference to an element configured to produce pixel values, is defined to encompass a configuration of multiple processors (e.g., GPUs) operating in a coordinated fashion to produce pixel values of frames of a video signal.

A display server D100 includes at least two server programs 200a,b, each configured to process drawing requests and produce corresponding rendering commands. A drawing request is a device-independent command or sequence of commands to draw a graphics primitive to an image. A rendering command is a device-specific command or sequence of commands to render pixel values to a storage area such as a display buffer. A server program may also be configured to issue replies to clients and/or to send information to clients such as information received from an input device 50. In some applications, one or all of the server programs 200 may be implemented as or derived from a server program 20 as described above.

Each server program 200 executes on the CPU of display server D100. Server programs 200a,b may execute on the same processor, on different portions of a multicore processor, or on different processors. The server programs are typically implemented as user processes, which execute in user space as opposed to processes (such as the operating system kernel, kernel extensions, and kernel-mode drivers) that execute in kernel space. The distinction between user space (also called application space or user level) and kernel space is well-known in the art and is maintained by the operating system of a device. In a typical implementation of display server D100, server programs 200 are co-resident in system memory, running as separate user processes and executing independently of one another, although in some cases a server program 200 may be configured to communicate with another server program 200. Access to common resources such as graphics bus B10 or system memory may be arbitrated by an operating system 80 of the display server and/or by another resource management structure such as a semaphore, in which case a server program 200 may receive an interrupt or other message (e.g. from operating system 80) indicating that a requested resource has become available. Depending on the particular application, a server program 200 may be implemented as or based on a server program 20 as described above with reference to various implementations of display server D10.

Server programs 200a,b may be implemented as different instances of the same program. For example, more than one of the server programs 200 may be loaded from the same executable file (e.g. as stored on a disk drive of display server D100 or as received by display server D100 over a network). The different instances may have minor differences during execution. For example, different instances of server program 200 may be configured to show distinguishing indicia on the display screen. Operating system 80 may be arranged to configure an instance of server program 200 according to options specified in a configuration file. In some such cases, operating system 80 is arranged to configure different instances of server program 200 according to different respective configuration files. Server programs 200a,b may also be implemented as different software programs. Further embodiments as described herein include a display server having a primary server program and a secondary server program, and a display server having a multiple-state server program.

A server program 200 includes device-independent code and device-dependent code. For example, a server program 200 may be implemented as an “X server,” or a server program based on a reference implementation of the X Window System (X.Org Foundation, a Delaware LLC). Common versions of the X Window System include X Consortium Standard X Version 11 (“X11”) and Release 6.3 (“X11R6.3”), X.Org Release 6.8.2 (“X11R6.8.2”), and versions released by the XFree86 Project, Inc. An X server provides network-based display services to clients and may also respond on behalf of clients to user interface events (such as mouse and/or keyboard input) and protocol requests (graphics). In one example, client programs are implemented as X clients, each executing on one or more processors (possibly two or more executing at least in part on the same processor).

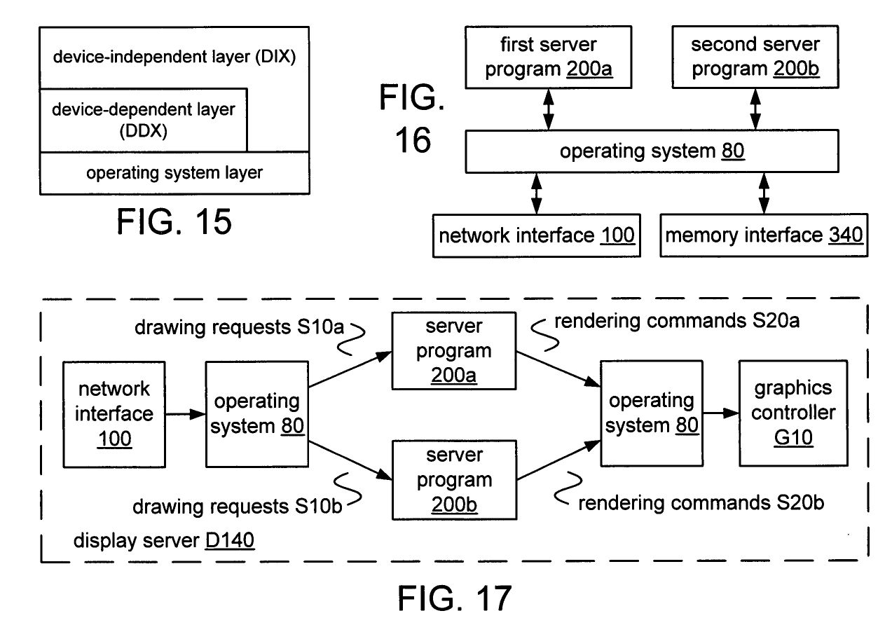

FIG. 15 shows a diagram of the layered architecture of a typical X server. The device independent (DIX) layer handles communications with clients (via the X protocol) and manages one or more queues of events such as incoming drawing requests and outgoing input events. The DIX layer includes functions that do not depend on the graphics hardware, input devices, or operating system, and code in the DIX layer is common to implementations of the X server on different platforms.

The device dependent (DDX) layer shown in FIG. 15 communicates with the DIX layer and includes code that may differ from one platform to another, depending on graphics controller G10 and/or an operating system of display server D100. The DDX layer includes instructions specific to the graphics hardware, such as a write of a particular value to a particular register in order to perform an operation such as drawing a line, and may be developed based on the manufacturer's documentation for graphics controller G10 (e.g. the instruction set of processing unit 310). The DDX layer may be tailored to include features for a particular market and application, such as enhanced 2D performance, and may be adapted to any type of graphics hardware. The DDX layer may also be configured to relay input events to the DIX layer. In some cases, the DDX layer may be implemented as one or more separable components of server program 200, such as a loadable module. For example, the DDX layer may include one or more device drivers and/or libraries, which may be supplied by a manufacturer of graphics controller G10.

In another example, the device-independent portion of server program 200 includes an application programming interface (API) configured to process DirectX commands (for example, DrawPrimitive) and/or OpenGL commands (for example, GL-TRIANGLE, GL-QUAD). In such case, the device-dependent portion of server program 200 may include routines that are specific to graphics controller G10 and/or processing unit 310, such as a device driver.

Communication between network interface 100 and server programs 200a, 200b, such as the transfer of drawing requests and/or input events, may occur via an operating system 80 of display server D100. For example, a connection between a client and server program may be set up and implemented via calls to a kernel or service of operating system 80. FIG. 16 shows a block diagram of an implementation D120 of display server D100 that illustrates transfers of drawing requests from network interface 100 to server programs 200a,b via operating system 80, which may be implemented as Linux or another variant of Unix, Windows XP or another version of Microsoft Windows, Tiger (MacOS X) or another version of a Macintosh operating system, or another operating system. For example, such transfers may be performed via a kernel driver or similar service.

As shown in FIG. 15, a server program 200 may include a layer configured to interface with operating system 80. This operating system layer may be implemented to include code which relies on operating system 80 and differs for different operating systems. The operating system (OS) layer of an X server handles procedure calls and communication with other processes via operating system 80 and may also manage connections between server program 200 and one or more clients 40. The OS layer may also include routines for allocating memory to the server program 200.

A server program 200 may be implemented to operate in a rooted configuration or a rootless configuration. In a rooted configuration, the server program 200 controls drawing of the top level desktop. For example, display server D100 may be implemented such that the visible server program 200 controls drawing of the top level desktop. In a rootless configuration, another application controls the desktop, such as a primary server program 200 or another program such as a display manager. Examples of display managers, which may communicate with X servers via a version of the X Display Manager Control Protocol (XDMCP), include X display manager (xdm), KDE display manager (kdm), and gnome display manager (gdm).

A typical X server includes an extension interface, which may be used to extend the operation of the X server to include functions that are not present in the core X protocol. One or more of the server programs 200 may be implemented by adding one or more extension routines to an existing X server. For example, such a routine may be configured to access the extension interface to support extension calls from clients 40 that relate to input context and/or display context, such as display context switch commands.

Based on an existing server program designed for graphics controller G10, it may be possible to implement server programs 200a, 200b with relatively few changes. In deriving a server program 200 from an existing X server, for example, it may not be necessary to change the DIX layer, and a baseline functionality may be obtained with only a few changes to the DDX layer and/or protocol extensions to support operations relating to input context and display context as described herein, such as sharing of the graphics hardware and switching on some external X input (e.g. via input manager 500).

A drawing model as implemented by a server program 200 may be stateless, such that the server program has no knowledge of primitives it has already drawn. In such case, a server program may be configured to redraw each frame rather than indicating changes to a previously drawn frame. Persistence of a background (such as a map) from frame to frame may be obtained by the use of one or more overlay planes, which may be cleared for a new image without affecting the background.

Drawing requests S10a,b are high-level, device-independent graphics descriptions that are abstracted from the actual graphics hardware. The drawing requests are independent of the particular type or manufacture of graphics controller G10, such that a client 40 may issue drawing requests without regard to the underlying graphics hardware. The drawing requests may also be independent of operating system 80, such that client 40 and display server D100 need not run the same operating system.

A drawing request includes a request to draw a graphics primitive such as an arc, line or polygon at a particular location in a coordinate system (2D or 3D). In one example, drawing requests S10a,b are compliant with at least one version of the X Window System Protocol (“the X protocol”). Examples of drawing requests supported by the X protocol include PolyPoint, PolyLine, PolySegment, PolyRectangle, PolyArc, FillPoly, PolyFillRectangle, and PolyFillArc.

A drawing request may specify a color, size, line weight (thickness), line style, fill style, position in a 2-D or 3-D display space, and/or text label for the requested primitive. Alternatively, the drawing request may indicate a graphics context that includes at least some of this information. In the X protocol, for example, each drawing request is associated with a graphics context, and a server program may also receive commands to alter an aspect of a graphics context.

A drawing request compliant with the X protocol typically includes codes that identify the desired operation, the graphics context to be used, the drawable (e.g. window or pixmap) to which the primitive is to be drawn, and other data such as the location of the primitive to be drawn relative to an origin of the drawable. In other examples, a drawing request may specify one or more triangles, rectangles, or other graphics primitives in a form that is compliant with another high-level graphics interface such as OpenGL or DirectX.

Drawing requests processed by a server program 200 may correspond to real-world events and may represent changes over time in a progression of such events. For example, a drawing request may indicate an aspect of a physical process being monitored in real time. In one class of such applications, drawing requests S10a,b indicate the current positions of transportation vehicles, such as moving aircraft. Such positions may be sensed using radar and/or GPS. Display of such dynamic information may be overlaid onto a static image, such as a surface map, and/or may be combined with one or more images of other dynamic information, such as a weather map. Server program 200 and/or client 40 may also include support for panning the display window across a larger virtual image (e.g. according to commands entered via an input device 50).

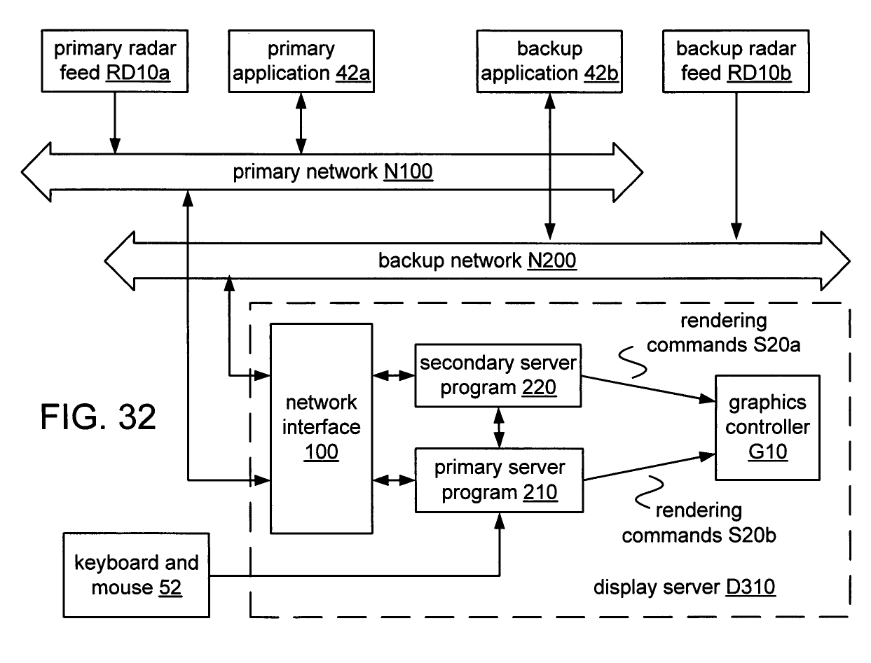

It may be desirable for images specified by drawing requests S10b to be based on the same activity and/or positions as images specified by drawing requests S10a. For example, it may be desirable for images specified by drawing requests S10b to include redundant representations of the same dynamic physical process as images specified by drawing requests S10a. For such a case in which drawing requests S10a,b indicate the current positions of a set of transportation vehicles, the two sets of drawing requests S10a,b may each indicate a current position for each vehicle (e.g. aircraft) in the set. The respective clients 40a,b may, compose their respective drawing requests from the same input information or from redundant sources. For example, FIG. 32 shows an example of an installation in which each client application 42a,b receives input information from a different one of two radar feeds RD10a,b.

Display server D100 may be configured to receive drawing requests for server programs 200a and 200b asynchronously. During a period of receiving requests for server program 200a to draw objects to a first image, for example, display server D100 may receive requests for server program 200b to draw objects to a second image. In a typical application, clients are not aware of one another, and access to a shared network may be arbitrated at a physical level, such as by collision detection. An implementation of display server D100 that supports connections to multiple networks (via a network interface 110, for example) may be configured to receive drawing requests for server programs 200a and 200b simultaneously.

A rendering command includes one or more codes indicating a desired operation and may also include associated data such as location and/or color. A rendering command may indicate pixel values indirectly by specifying the vertices of a graphics primitive (e.g. a line, triangle, quad) or set of primitives (e.g. a quad strip or triangle fan). Such rendering commands are also called “hardware acceleration commands.” Alternatively, a rendering command may explicitly indicate a value (e.g. an RGB value) to be assigned to a pixel; may assign a pixel value according to a location in a bitmap, texture map, or other type of map; and/or may assign a pixel value based on a lighting operation or other rendering operation. Such rendering commands are also called “value assignment commands.” While value assignment is typically much slower than hardware acceleration, an appropriate hardware acceleration command may not be available for a particular object or pattern to be drawn (for example, an unusual dash/dot line pattern).

Rendering commands S20a,b may be compliant with an instruction set of the processing unit 310. For example, a rendering command S20 typically includes one or more opcodes, which indicate operations to be performed by the processing unit 310, and one or more operands, which indicate registers of the processing unit 310, addresses in local memory 330, and/or data values to be processed according to that operation or operations. Rendering commands S20a,b may also be compliant with a shading language such as ARB Shading Language (Architecture Review Board) or OpenGL Shading Language (OpenGL), Cg (NVIDIA), or DirectX High-Level Shader Language (HLSL) (Microsoft).

Delivery of rendering commands 520a,b to graphics controller G10 for execution may occur by any path or procedure suitable for the particular implementation of display server D100. Typically, a server program 200 is configured to store rendering commands to system memory, and the rendering commands are then copied to local memory 330 for execution by graphics controller G10. For example, a server program 200 may store rendering commands to a command buffer in system memory, with contents of the buffer being copied periodically (e.g. via memory interface 340) to a command buffer in local memory 330. One or both of these buffers may be implemented as a circular queue (also called a circular buffer or ring buffer). Copying of rendering commands may be initiated upon a specified fill condition of the buffer in system memory and/or of the buffer in local memory 330. Display server D100 may be configured such that rendering commands outputted by different server programs 200 are stored to respective buffers in different areas of system memory.

Writing of the rendering commands to local memory 330 (e.g. via memory interface 340) may occur individually or in blocks and may be performed via operating system 80. For example, graphics controller G10 and/or a central processor of display server D100 may initiate a transfer by calling a function of operating system 80. Such a call may include a request to invoke a particular interrupt vector, causing a read from (and/or a write into) a buffer associated with that vector. It may be desirable to transfer the rendering commands into local memory via a direct memory access (DMA) operation and/or one or more intermediate buffers such as a paging buffer. FIG. 16 shows an example of a logical architecture of paths for data transfer via operating system 80 among the server programs 200, network interface 100, and memory interface 340. FIG. 17 shows an example of a virtual path of data transfers across such an implementation D140 of display server D110 including operating system 80.

Alternatively, graphics controller G10 may obtain rendering commands S20a,b by accessing system memory. Such access may occur over a PCI, PCI Express, or AGP bus via an aperture mechanism such as a Graphics Address Remapping Table (GART), which translates virtual addresses referenced by graphics controller G10 into physical addresses in system memory. Graphics controller G10 may be configured to execute rendering commands directly upon reading them or to store the rendering commands to a command buffer in local memory 330.

As a practical matter, graphics bus B10 may be available to only one process at a time, such that transfer of rendering commands from each server program 200 to graphics controller G10 may be arbitrated to occur at different times. Nevertheless, in at least some such implementations, rendering commands S20 from both server programs 200a and 200b are transferred to graphics controller G10 during one frame period of video signal S30 (the period of a vertical synchronization signal of video signal S30, or the interval between successive scans of the same location of a currently visible display buffer). Display server D100 may be implemented such that during a period of scanning out one frame of video signal S30, a set of rendering commands describing an entire display image is transferred to graphics controller G10 from each one of the server programs 200.

It may be desirable to ensure that each server program 200 shares graphics controller G10 without disturbing an image drawn by another server-program 200. Rendering commands typically proceed through a graphics controller in a serial stream, and it may be desirable to ensure that rendering commands from different server programs are used to update the correct display buffer.

It may be desirable to maintain a separate queue of rendering commands for each server program 200. For example, different areas of local memory 330 may be reserved as command buffers, with each buffer holding a queue of rendering commands from a different server program 200. Such command buffers may reside within memory that is on an expansion card of graphics controller G10 or even within processing unit 310, and writing of rendering commands into one or more command buffers may be performed via memory interface 340. It may be desirable for a command buffer to occupy a contiguous portion of memory, which may simplify implementation of a circular queue (also called a “circular buffer” or “ring buffer”). Otherwise, the notion of command buffers is a logical abstraction, and such buffers may be physically located, maintained, and transferred in a manner suitable to any technique of memory management and allocation used by operating system 80, memory interface 340, and other hardware and/or software of display server D100.

Graphics controller G10 may be configured to execute rendering commands from one queue at a time and to switch periodically between queues to execute rendering commands from different server programs 200. Similarly to the execution of an instruction in any other thread, the execution of a rendering command may assume that a particular “context” or state exists within graphics controller G10. For example, execution of a rendering command may produce the desired result only if particular values are already stored in one or more registers of processing unit 310. Thus it may be desirable for graphics controller G10 to perform a rendering context switch when switching execution from one queue of rendering commands to another.

Most GPUs currently available include support for multiple rendering contexts. For example, a server program may use multiple rendering contexts to support asynchronous display of multiple windows within the same display frame. The GPU time-shares between different rendering contexts, executing commands from a circular buffer corresponding to one window for some period, then executing commands from a circular buffer corresponding to another window for some period. Typically the switching happens so rapidly that the video display remains smooth.

Display server D100 may be configured to maintain different rendering contexts for different corresponding command buffers. Switching of the rendering context between queues of different server programs 200 (for example, between the visible server program and one that is not currently visible) may occur during rendering of a video frame, possibly several times.

As noted above, switching between multiple rendering contexts may be performed periodically. For example, rendering context switching may occur according to a signal received from a timer, which may be internal to processing unit 310 and/or graphics controller G10 and may be programmable. Such a timer may be configured to trigger rendering context switching by issuing an interrupt request to processing unit 310. Timer control of rendering context switching may also help to prevent a problem with one server program 200 from stalling display server D100.

Access to a rendering pipeline of processing unit 310 may also be arbitrated on another basis. For example, switching between rendering contexts may be performed upon execution of a predetermined number of rendering commands since the last rendering context switch, on a frame-by-frame basis, according to a command or switch code stored in the command buffer and encountered upon retrieval and execution of other commands stored therein, or upon another signal to processing unit 310 or graphics controller G10.

Processing unit 310 may be configured to automatically switch between multiple rendering contexts. For example, processing unit 310 may be configured to keep track automatically of time-sharing between the command buffers, such that it may be sufficient to inform processing unit 310 where to find the buffers and how large they are (e.g. by writing the relevant information to one or more particular registers). In some cases, the size of the time-slice for each command buffer may be specified (e.g. by writing a value to a corresponding register). Processing unit 310 may also be configured to determine that rendering commands are available for execution by monitoring writing activity to the command buffers.

It may be desirable to perform switching of the rendering context in a manner that is transparent to server programs 200. For example, it may be desirable for graphics controller G10 to keep track of contextual characteristics, such as the current line color and width, so that it is not necessary for a server program 200 to reset these parameters upon a rendering context switch.

Switching between rendering contexts may include caching or otherwise storing the current context information (such as some or all of the current contents of the register file of processing unit 310) and loading the new context information (e.g. some or all of a previous contents of the register file of processing unit 310). Such information may include a value indicating a location of the next instruction to be executed in each context (for example, the corresponding contents of a program counter of processing unit 310).

Processing unit 310 may be configured to store rendering context information to a location in local memory 330 that is associated with a command buffer corresponding to that context. For example, processing unit 310 may be configured to store rendering context information at a particular offset within a region that contains the command buffer. The location (e.g. the offset) may be indicated by a command to processing unit 310 and/or by the contents of a corresponding register of processing unit 310. The memory interface is typically so fast that a context switch may be completed in twenty microseconds or less, whereas retrieving the information from system memory could take milliseconds. While the context information is typically stored in dedicated memory of graphics controller G10, it may also be cached (e.g. within processing unit 310) for even faster access.

A server program 200 may issue rendering commands to more than one queue. In addition to the queues corresponding to each different instance of server program 200, for example, different queues may be maintained for each window in a multiple-window image drawn by a server program 200. A server program 200 may even issue rendering commands to queues corresponding to different images (with only a selected one of the images being visible, for example, or with different images being displayed on different display devices 60). In such case, graphics controller G10 may be configured to render pixel values for the different images into different display buffers.

Each queue of rendering commands may have a different corresponding rendering context. For example, different images may be associated with different graphics contexts or otherwise have different element characteristics. Different images may also be associated with different clients. The server program 200 may be configured to switch from one image to another (e.g. between windows of a screen image) according to a user input or other event. The server program 200 may also be configured to issue a corresponding focus signal to the respective client that indicates which image (e.g. window) is currently visible.

In typical implementations of display server D100, graphics controller G10 and/or processing unit 310 is configured to execute rendering commands produced by a server program 200 and to store the resulting pixel values to a corresponding display buffer. In this document, the term “display buffer” is used to indicate a portion of memory to which the display frame (in other words, the screen image) is rendered and from which the display frame is scanned out to the display device. This term is similar to the term “frame buffer,” which may be used in various contexts to indicate a display buffer, the collective area of memory to which rendered pixel values are stored, or the on-board memory of a graphics controller.

Graphics controller G10 and/or processing unit 310 may be configured to execute rendering commands produced by each of the server programs 200 and to store the resulting pixel values corresponding to different server programs in different respective display buffers. The display buffers may be stored together (e.g. consecutively) in local memory 330, or each display buffer may reside in a different area of memory. Graphics controller G10 and/or processing unit 310 may also be configured to store rendered pixel values corresponding to different screen images produced by the same server program 200 to different display buffers.

In a typical implementation of display server D100, graphics controller G10 switches from one queue (e.g. command buffer) to another to execute, during one frame period, rendering commands produced by each one of the server programs 200, regardless of which server program 200 is visible. In an alternative implementation of display server D100, graphics controller G10 executes only those rendering commands produced by a server program 200 which is currently visible. In this case, it may be desirable to flush unexecuted and stale rendering commands from the command buffer of a nonvisible server program 200. For example, such flushing may be necessary to allow new rendering commands to be stored. One flushing technique includes queuing the rendering commands using a temporal marker such as a timestamp or framestamp, and flushing the command buffer periodically according to this marker.

Some image disruption may occur upon a display context switch if the current frame for the selected server program 200 has not yet been rendered. This disruption may be reduced by delaying the display context switch for one frame, or until the new frame can be rendered to its display buffer. In such case, the context switch may be performed quickly enough that the operator does not perceive any delay. In a case where only the rendering commands for a visible server program 200 are executed, the same display buffer may be used to store pixel values from different server programs 200 at different times. Again, it is noted that a typical implementation of display server D100 executes, during one frame period, rendering commands produced by each one of the server programs 200, regardless of which server program 200 is visible.

It may be desirable for a display buffer to occupy a contiguous portion of memory, which may simplify a scanout operation by display interface 320. Traditionally, a display buffer was arranged as a linear array, with blocks of values corresponding to successive screen lines being stored one after the other. For throughput efficiency, one or more of the display buffers may be arranged as rectangular tiles instead, with each tile representing a two-dimensional block of pixels (e.g. 8×8 pixels). If a scene being rendered includes many small primitives, accessing the memory as tiles may greatly reduce the total amount of memory traffic needed to render the scene, because a single tile may contain an entire primitive. Tiles need not be rectangular, and tile size and shape may be selected according to factors such as expected size and shape of a graphics primitive and the physical configuration of the local memory (e.g. size and shape of the display area corresponding to a portion of the memory that may be accessed in one operation). Otherwise, the notion of display buffers is a logical abstraction, and such buffers may be physically located, maintained, and transferred in a manner suitable to any technique of memory management and allocation used by processing unit 310, memory interface 340, display interface 320, and/or other components of display server D100.

Command and display buffers may reside in the same physical and/or logical memory, or in different physical and/or logical memories. For example, the display buffers may reside in on-board memory, while the command buffers reside in on-chip memory. Embodiments of display server D100 include configurations in which the display buffers reside in memory dedicated to the graphics controller, configurations in which the display buffers reside in system memory, and configurations in which the display buffers may reside in either or both memory spaces. Other embodiments include the use of a Unified Memory Architecture (UMA), in which the CPU and processing unit 310 share one memory space.

In one example, local memory 330 includes an on-board block of 256 MB, although the size of the on-board memory may vary from one type or version of graphics controller to another and is not a limitation on the principles disclosed herein. When a server program 200 is loaded, one or more portions of this block are allocated to it. Such allocation may be performed, for example, by writing values to one or more registers of processing unit 310, to memory interface 340, and/or to one or more locations in system memory. Alternatively, allocation may be performed before the server program is loaded (e.g. by an initialization routine) or may be requested by the server program after it is loaded. The allocated portions of memory, which may include at least one display buffer, may be reserved for use by the corresponding server program.

Limits may be applied to the operations of the server programs 200. As the amount of available memory is limited, for example, it may be desired to prevent either of the server programs from using it all to the detriment of the other. Resource use of the server programs may be managed by allocating a predetermined amount (e.g. one half), or no more than a maximum amount, of resources such as local memory 330 to each server program instance. Of a 256-MB graphics memory, for example, 128 MB may be allotted to each server program. Similarly, operating system 80 may be configured to allocate a restricted amount (e.g. one half) of system memory to each server program 200. As discussed in further detail herein, operating system 80 may obtain such a memory allocation limit from a configuration file of the server program 200. Alternatively, allocations may be restricted according to an expected need of the particular server program 200. Resource use limits may help to ensure reliably redundant operation of display server D100.

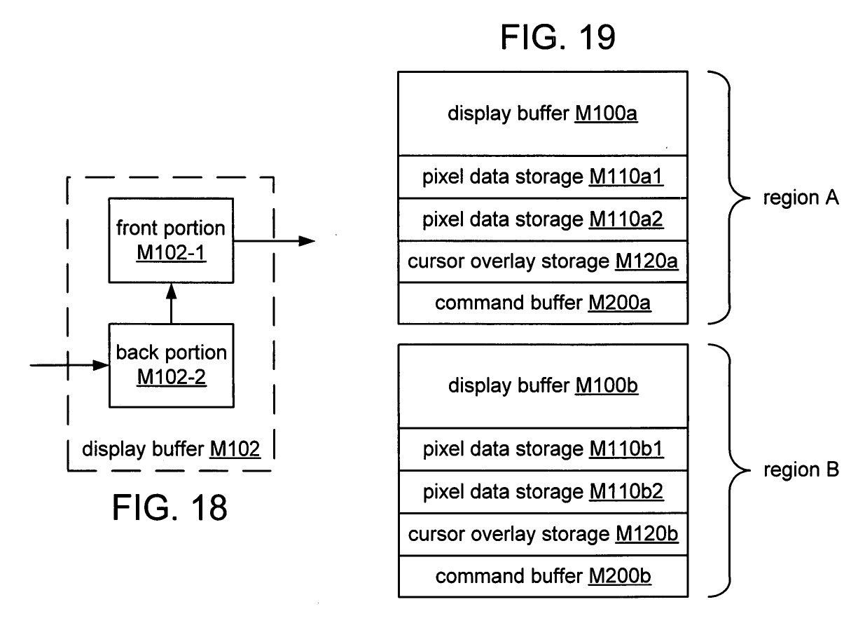

Display buffer M100 may support double buffering, in which an on-screen buffer is scanned out for display (e.g. by display interface 320 or memory interface 340) while pixels of the next frame are rendered to an off-screen buffer. FIG. 18 shows an implementation M102 of display buffer M100, which includes a back portion to which the image is rendered and a front portion which is scanned out for display. Graphics controller G10 and/or processing unit 310 may be configured to copy the contents of the back portion to the front portion after each frame scan is complete (for example, during a vertical retrace period), upon completion of the image being rendered, or according to some other procedure synchronized to the scanning operation. Such a transfer may be executed by memory interface 340 via a fast operation such as a bit-block transfer (or “blit”) and/or a direct memory access operation. A double-buffering operation may also be configured to copy to the front portion only areas of the back portion that have changed from the previous frame, which may reduce memory bandwidth consumption.

In the example of FIG. 18, the back portion is always off-screen. In another implementation, the rendering and scanning operations are synchronized to alternate at each frame between two portions of display buffer M100, such that a frame rendered off-screen to one portion is then scanned out from the same portion while the next frame is being rendered off-screen to the other portion.

Graphics controller G10 and/or processing unit 310 may be configured to store rendered pixel values to display buffers of both server programs 200 during a frame period, with only one of the buffers being scanned out for display. A display context selector 820 determines which buffer (or, for a dual-head display, which buffers) is scanned out for display. Display context selector 820 may be implemented to include an element of graphics controller G10, such as one or more registers of processing unit 310. One or more indications of the locations to read from (e.g. a starting address of one or more selected display buffers) may be written to this register or registers by a server program 200, by a window manager program, and/or by an input manager 500 as described herein. Display server D100 may be configured such that when a server program 200 is designated as the visible server program, the server program (or another element of the display server) updates this indication or indications.

Graphics controller G10 and/or processing unit 310 may be configured to access different types of information corresponding to each server program 200. These different types of information may be stored in different areas of memory. As discussed above, for example, graphics controller G10 and/or processing unit 310 may read rendering commands stored in one or more command buffers and store rendered pixel values to one or more display buffers. Graphics controller G10 and/or processing unit 310 may also be configured to read rendered pixel values, masks, and/or overlays from (and/or store such information to) one or more off-screen areas or “workspaces.” Client programs typically issue requests to draw portions of more complex images to off-screen surfaces, which are called “pixmaps” in X Window System terminology. Once an image portion is complete, it may be copied from the off-screen pixmap to an appropriate area of a display buffer for scanout. Drawing to off-screen memory may help to minimize effects of flicker or flash during the erase or redraw, and it may be desired to assemble entire display frames from images rendered off-screen in this manner.

Image portions stored to the workspace may include one or more overlay images, and an image for display may be assembled from a background image and one or more overlay images applied to the background as planes or masks. In an air traffic application, for example, images indicating such information as locations and identities of aircraft may be overlaid on a background image of a map. The cursor image is also typically implemented as an overlay. In some cases, different clients may generate the drawing requests used to create the background and the overlay. A common background and/or overlay image may be used in some implementations to assemble images corresponding to different server programs 200.

It may be desirable to allocate different amounts of storage to different types of information. While a command buffer is typically a relatively small buffer of about 64 kilobytes or 256 kilobytes, for example, it may be desired to reserve an area of tens or even hundreds of megabytes for storage of rendered pixel values. Allocating a region of memory may include writing values indicating the desired location and size of the region to one or more registers of graphics controller G10 and/or processing unit 310. Depending on the particular implementation of display server D100, such values may be written according to one or more commands issued by server program 200, operating system 80, and/or graphics controller G10, and regions may be allocated from local memory 330 and/or from system memory. While regions are typically implemented as nonoverlapping areas of memory, in some implementations it is possible for separate regions to be implemented as overlapping (e.g. interleaved) areas of memory.

Information may be stored in different formats from one region to another. For example, pixel values stored in different regions may have different color depths (typically 8, 16, or 24 bits per pixel). Images or image portions may be drawn to different regions according to different screen resolutions (e.g. as expressed in height and width in pixels). Pixel value storage in different regions may also be organized according to different tiling schemes.

A server program 200 may use a device-independent style of pixel addressing. For example, a server program 200 may identify a particular pixel in terms of its x- and y-screen or window coordinates (e.g. as “(y_coordinate*bytes_{—}per_line)+x_coordinate”). However, it may be desirable for graphics controller G10 (e.g. processing unit 310 or memory interface 340) to manage access to different areas of pixel value storage according to different addressing schemes, depending on factors such as color depth and tiling scheme. Switchign between rendering contexts or display contexts may include configuring one or more memory access operations to point to a different area of pixel value storage, which may include using a different addressing scheme.

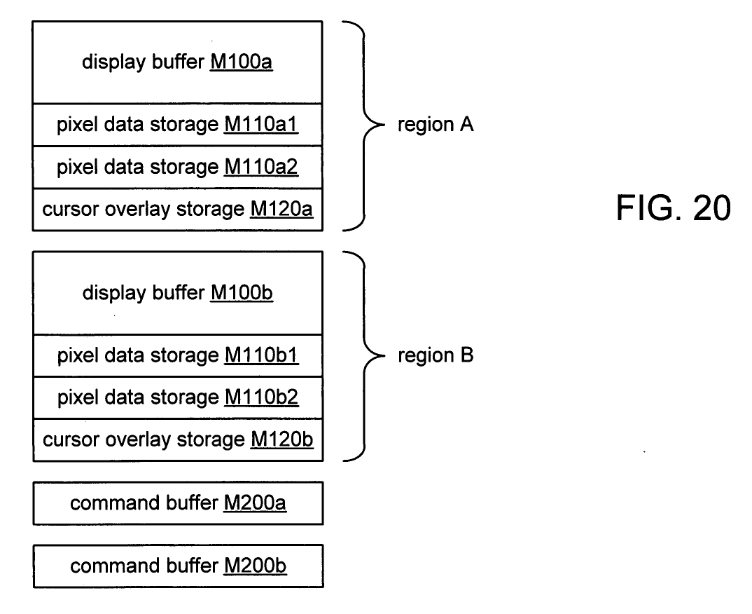

FIG. 19 shows one example of different storage areas in a region A allocated to server program 200a and a region B allocated to server program 200b. In other examples, more than one region of local memory is allocated to a server program. The example of FIG. 19 also shows a command buffer included in each region. However, it may also be desirable for graphics controller G10 to access a queue of rendering commands without using any particular addressing scheme, and FIG. 20 shows another example in which the command buffers lie outside regions A and B (e.g. in a different region).

One technique of applying different addressing schemes to different portions of pixel value storage is to store information defining the addressing scheme for a particular region of local memory to a corresponding region format register. It may be desirable to assign such a register or registers to any storage area that contains pixels (such as a display buffer and a workspace), and values stored therein may be references by processing unit 310, display interface 320, and/or memory interface 340 to locate, read, and/or write data to and from the region.

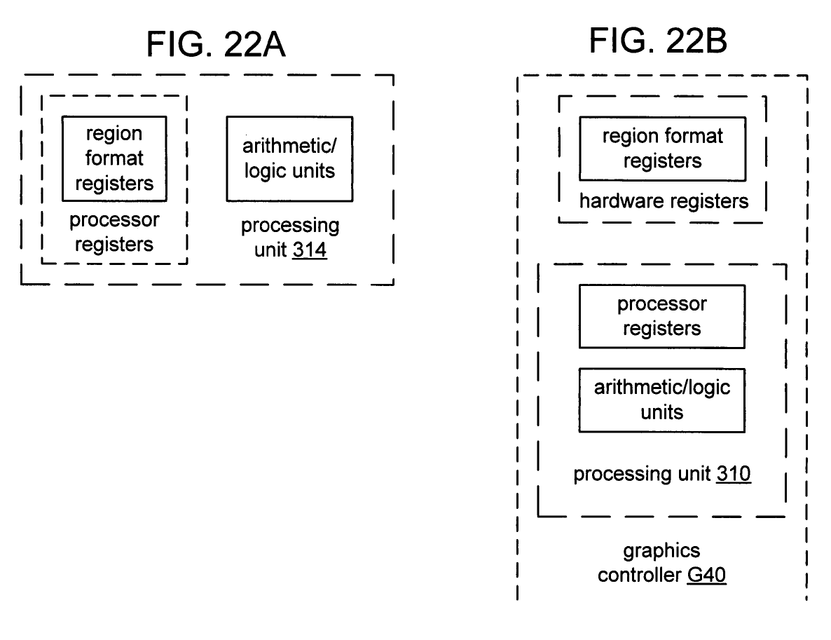

FIG. 22A shows a block diagram of an implementation 314 of processing unit 310 that includes on-chip region format registers. These registers may be included among a set of registers within (e.g. a register file of) processing unit 314. FIG. 22B shows a block diagram of an implementation G40 of graphics controller G10 that includes region format registers among a set of hardware registers that reside separately from the registers within processing unit 310. For example, the hardware registers may reside on another chip in the package of processing unit 310 or within an on-board memory of graphics controller G40.

One or more region format registers may be associated with each allocated region, and storage of the region format to one or more such registers may be executed as part of a memory allocation operation or as a separate operation performed before or after allocation. In one particular example, the P20 graphics chip (3DLabs) has sixteen region format registers, each of which can define the formatting attributes for a range of memory not exceeding 16 MB. In a display server D100 including another implementation of processing unit 310, it is possible that the use of such registers may not be necessary, or that other memory access techniques may be used to account for differences in factors such as color depth (e.g. 8, 16, or 24 bits per pixel) and tiling scheme.

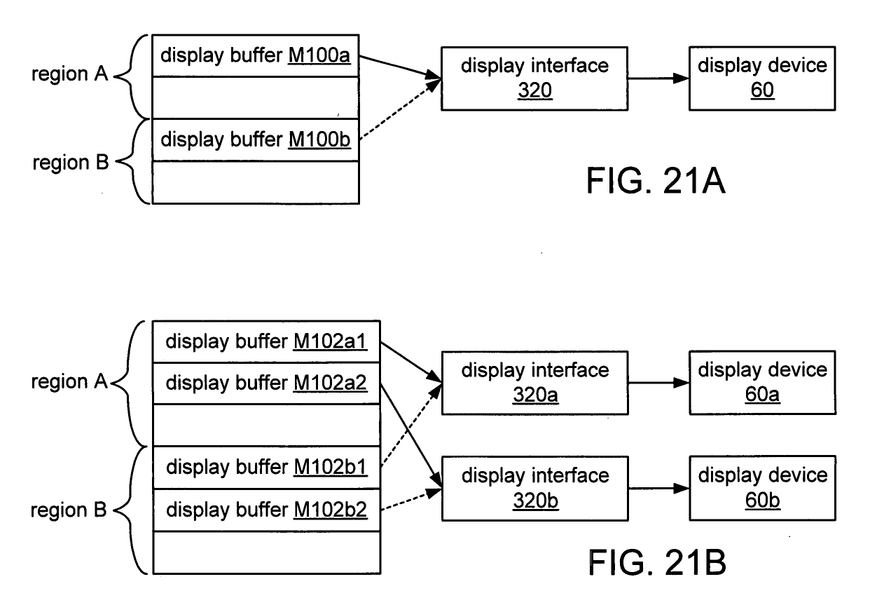

FIG. 21A shows an example of a display signal path from a selected one of two display buffers M100a,b to a display device 60. Based on pixel values from the selected display buffer, display interface 320 produces a display signal S50 for display by display device 60. In a typical example, display interface 320 receives the pixel values via a scanout operation of the display buffer by memory interface 340. Memory interface 340 may perform the scanout operation according to an offset value indicating a starting address of the display buffer (e.g. as stored in a register according to a display context signal S50). In order to obtain a smooth display context switch between different display buffers, it may be desirable to use the same resolution and/or format (e.g. color depth, tiling scheme) for pixel values stored to those display buffers.

A server program 200 may be configured to render more than one image at once (possibly having different resolutions or color depths). In such case, display server D100 may be configured to output a separate display signal S50 for each image. FIG. 21B shows an example of a dual-head display signal path including two (possibly dissimilar) instances of each of display interface 320 and display device 60. In this example, one server program 200a draws to two different display buffers M102a1,2 in one memory region A of the local memory, while (in parallel) another server program 200b draws to two different display buffers M102b1,2 in another memory region B. Each display interface 320a,b may be configured to scan out the corresponding selected display buffer, or the scanout operations may be performed by one or more memory interfaces 340.

The display context state of display server D100 determines which of the server programs 200 are currently visible. For example, the display context state may indicate which display buffer is to be scanned out to produce video signal S30. In a typical implementation, display server D100 is configured to switch its display context from a state corresponding to one of the server programs 200 to a state corresponding to another of the server programs 200 according to a display context switch command. The display context switch command may be issued by a client 40, by an operator of the display server (e.g. via an input device), or by another process such as a fault detection process (e.g. a resource manager as described herein).

Display server D100 may be implemented to allow an operator to initiate a display context switch using an input device 50 and/or to allow initiation of a display context switch over a network, such as by a client or a remote operator or supervisor. Display server D100 may also be implemented to initiate a display context switch automatically according to a condition within or outside display server D100, such as a timer expiration, a resource warning or overload, or an error report (e.g. from operating system 80).

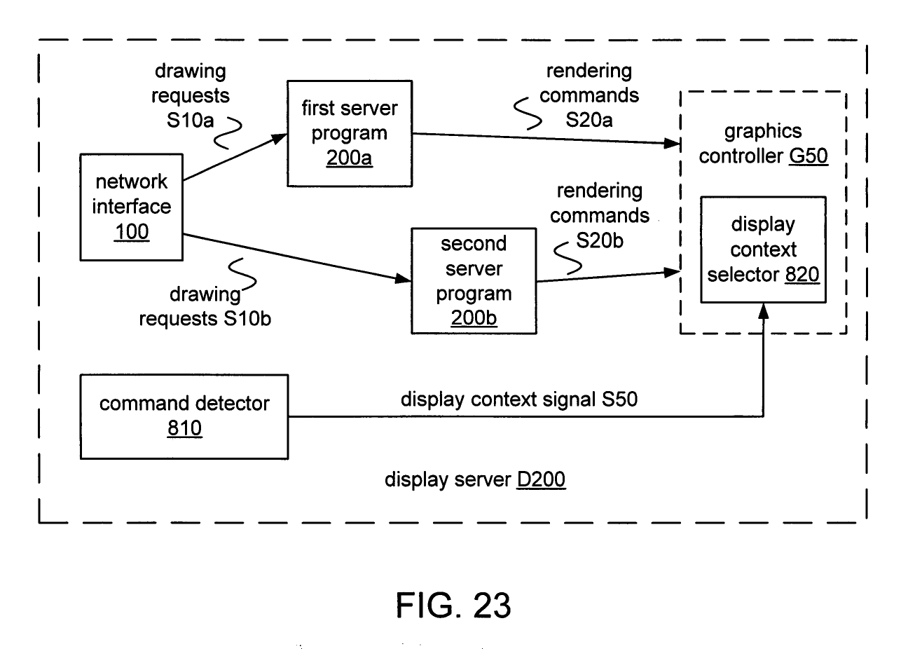

FIG. 23 shows a block diagram of an implementation D200 of display server D110 that includes a command detector 810 and an implementation G50 of graphics controller that includes a display context selector 820. Command detector 810 may be implemented in software and/or in firmware and may include one or more event-driven routines. In an implementation that supports multiple forms of display context switch command, for example, command detector 810 may be configured to detect such a command at more than one point within display server D100 and/or display server D100 may include multiple instances of command detector 810 adapted to detect various respective forms of display context switch command.

Command detector 810 is configured to output a display context signal S50 in response to the display context switch command. Display context signal S50 may explicitly indicate the selected display context state (e.g. which server program 200 is to be visible) or may indicate a toggle of the current display context (e.g. from one to the other of two states). According to display context signal S50, display context selector 820 selects a display context state of display server D100, such as a display context state of graphics controller G10. Selector 820 may be configured to select a display context state of graphics controller G10, for example, by indicating a display buffer to be scanned out for display. In an implementation of a display server supporting a dual-head display, selector 820 may be configured to select a display context state of graphics controller G10 by indicating more than one display buffer to be scanned out for display (e.g. one display buffer for each output video signal). As shown in FIG. 23, display context selector 820 may be implemented within an implementation of graphics controller G10, e.g. as one or more registers of processing unit 310.

It may be desired to support operator initiation of a display context switch, as in the KVM switch paradigm described above. For example, command detector 810 may be configured to recognize an input event, such as a particular keyboard action or set of actions, as a display context switch command. A single input action may be used to toggle between different display context states, or different input actions may be used to select different display context states.

One or more keys (for example, a special-use key such as a function key) may be reserved for entering display context switch commands. In one example, the keys F7 and F8 are reserved for selecting each of two different display context states. Alternatively, one or more combinations of keys may be reserved for entering display context switch commands (for example, a combination that is not likely to be depressed by accident, such as one that requires two hands to execute). In one example, the key combinations Alt-F7 (entered by simultaneously depressing the Alt and F7 keys) and Alt-F8 are reserved for selecting each of two different display context states. In another example, the key combination Alt-Tab is mapped to an action of toggling forward through a list of two or more display context states. A key or key combination that is mapped to a display context switch command is also called a “hot-key.” Display server D100 may also be configured to permit an operator to enter a display context switch command via another switch closure or input action, such as a mouse click on a specified region of a displayed image.

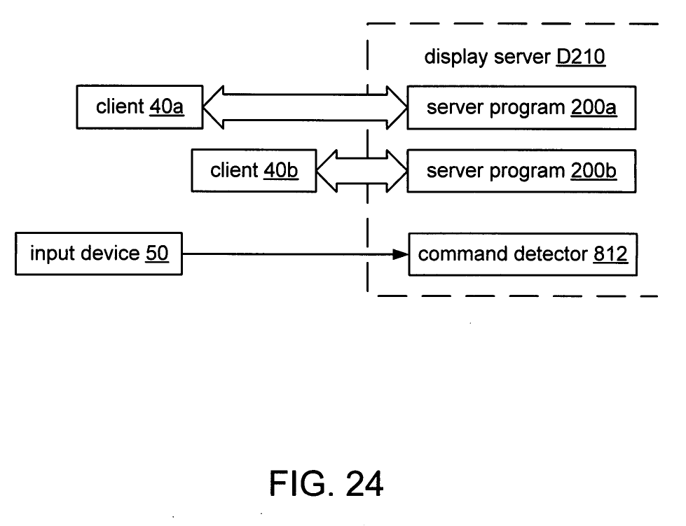

FIG. 24 shows a block diagram of an arrangement including an implementation D210 of display server D200 that supports operator initiation of a display context switch. In this example, an implementation 812 of command detector 810 is configured to receive a display context switch command entered via input device 50. The display context switch command may explicitly indicate a selected one of two or more display context states. Alternatively, the display context switch command may indicate a toggle of the display context from one to the other of two different states (e.g. each corresponding to a different server program 200). In an application supporting three or more display context states, the display switch command may indicate a toggle forward or backward through a list of available display context states.

Depending on the particular implementation of display server D100, detection of an input event indicating a display context switch command may be performed at any of several different points within the display server. For example, command detector 810 may include separate routines to monitor keyboard action, mouse action, network communications, timer expiration, and/or any of the other command assertion modes described herein.

In some cases, detection of a display context switch command may be performed at a low level within the architecture of display server D100. For example, a display context switch command may be directed to an interrupt request (IRQ) value of the CPU. In another example, detection of a keyboard event associated with a display context switch command is implemented by directing the keyboard interrupt vector to an interrupt service routine (ISR) of command detector 810. This ISR may be configured to scan the input stream for one or more particular keyboard events before invoking a conventional keyboard ISR of display server D100.

Alternatively, detection of a display context switch command may be performed at a higher architectural level, such as at the operating system level. For example, a dynamic link library (DLL) or device driver arranged to process input events may be modified to detect the particular event or events associated with a display context switch command. Detection of a display context switch command may also be implemented at the application level. For example, a window manager or other application or routine (e.g. an input daemon) that is arranged to forward information received from one or more input devices 50 and/or network interface 100 to one or more of the server programs 200 (e.g. the visible one) may also be implemented to include a command detector 810 (or a portion thereof) that is configured to detect the particular event or events associated with a display context switch command.

In such cases, detection of the display context switch command may be performed in a manner that is transparent to server programs 200. In other cases, one or more of the server programs 200 may be implemented to include a command detector 810 (or a portion thereof) that is configured to detect a display context switch command. For example, the currently visible server program may be configured to detect the display context switch command (e.g. a hot-key) and execute the indicated display context switch. Alternatively, one or more of the server programs 200 that are not currently visible may be configured to detect the display context switch command and execute the indicated display context switch.

In some implementations of display server D200, command detector 810 is configured to detect a display context switch command received over a network, such as from a client or a remote operator or supervisor. In such case, command detector 810 may be configured to detect an event such as the receipt via network interface 100 of a packet or other data transmission having a particular format or payload.

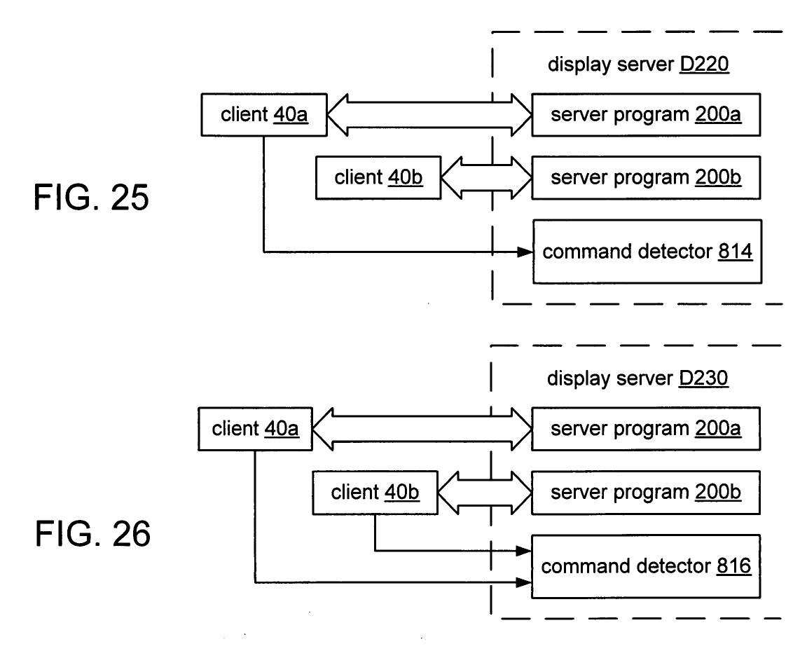

FIG. 25 shows a block diagram of an arrangement including an implementation D220 of display server D200. Display server D220 includes an implementation 814 of command detector 810 that is configured to detect a display context switch command received from a primary one 40a of two or more clients 40. For example, the communications protocol between client 40 and server program 200 (e.g. the X protocol) may be expanded to include a display context switch command, and command detector 814 may be configured to detect a display context switch command received via network interface 100.

FIG. 26 shows a block diagram of an arrangement including an implementation D230 of display server D200. Display server D230 includes an implementation 816 of command detector 810 that is configured to detect a display context switch command received from either of two clients 40a and 40b. Command detector 816 may be configured to detect a display context switch command received via one network port or via any of two or more network ports.

Detection of a display context switch command received over a network may be performed in a manner that is transparent to server programs 200. For example, command detector 810 (or a portion thereof) may be implemented in a device driver, dynamic link library (DLL), or other routine that interfaces network interface 100 to an operating system of display server D200. Alternatively, command detector 810 (or a portion thereof) may be implemented in a window manager or other application or routine that interfaces server programs 200 to an operating system of display server D200.

In other implementations of display server D200, one or more of server programs 200 are configured to detect a display context switch command received over a network. In such case, command detector 810 (or a portion thereof) may be implemented in an extension routine of the server program 200 that is configured to detect the command. Such a detector may be configured to output a corresponding display context signal S50 to the extension interface of the server program 200. Display server D200 may be configured to allow a client 40 to use such a command to force visibility of its server program 200.

A display server D110 may be configured such that if the network goes down or becomes disconnected, the last displayed image will remain on the screen. In a traffic control application, for example, display server D110 may be configured such that the vehicle tracks may stop moving but will remain on the screen. In case of network failure, it may be desired for the display server to notify the operator that the displayed image is no longer live.

Command detector 810 may be configured to detect a failure of a network (e.g. a physical break or disconnection), and/or a failure of a hardware element (e.g. a hard drive or memory module) of the display server, and to cause an indication of the failure to appear in the displayed image. For example, command detector 810 may be configured to trigger a routine in the corresponding server program to alter the displayed image. Such alteration may include changing an attribute of the image, such as one or more of its colors, and/or causing at least some of the pixels of the image to blink. Such alteration may also include adding one or more elements to the displayed image, such as an alert sign and/or symbol such as an X across the screen, which element or elements may be arranged as a blinking overlay to the image.

In addition (or in the alternative) to causing a displayed indication of a detected network or hardware failure, command detector 810 may be configured to process the failure as a display context switch command and to switch the display context state accordingly (e.g. to make visible a server program 200 that is not affected by the failure). Such operation may be desired, for example, in a redundant system having more than one network and/or more than one instance of the failed hardware element.

It may be desired to detect a failure of a software application, such as a client 40 or server program 200. For example, it may be desired for a server program 200 to detect failure of a client 40 and to display an indication of the failure (e.g. by altering the displayed image as described above) and/or to execute a display context switch. The server program may be configured to detect the client failure based on one or more conditions such as a lack of acknowledgement of transmissions to the client or a lack of drawing requests from the client over some interval. It may also be desired to detect a failure of a visible server program 200 or its client and to execute a display context switch to another server program 200. In such case, detection of a failure relating to one server program 200 may be performed by operating system 80 (e.g. by detecting a closed socket connection) and/or by another server program 200 (e.g. according to a report of a closed socket connection).

Display server D100 may be implemented to include a timer configured to expire after a predetermined interval (e.g. by counting down to zero or, alternatively, by counting up to an endpoint). The timer is arranged to be reset periodically by one or more elements being monitored, such as an application (e.g. the visible client 40 and/or visible server program 200) or hardware component. If the reset action does not occur before the timer expires, a failure of the element being monitored is indicated. A timer used for such a purpose is commonly called a “watchdog timer” and may be implemented in hardware and/or in software.

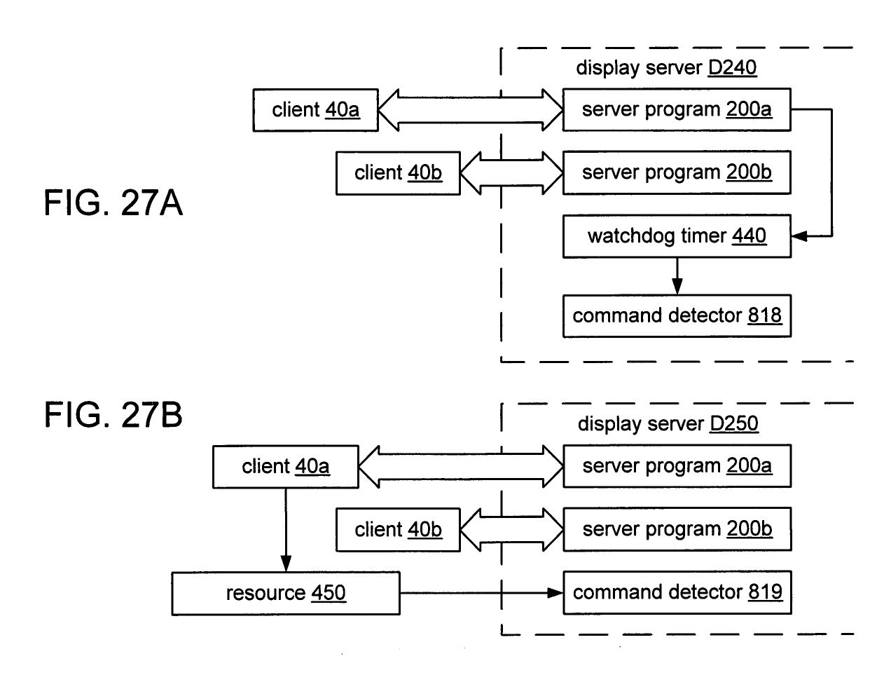

Display server D100 may be configured to indicate timer expiration by altering the displayed image and/or by executing a display context switch. For example, command detector 810 may be configured to receive the timer expiration signal as a display context switch command. FIG. 27A shows a block diagram of an implementation D240 of display server D200 that includes such an implementation 818 of command detector 810 and a watchdog timer 440. In this example, server program 200a is configured to reset the timer periodically, and the timer detects a problem with the server program by expiring. Timer 440 may be configured to monitor (and be reset by) whichever server program is visible. In a further implementation, timer 440 is configured to be reset according to a signal from a client (e.g. a currently visible client).

Upon expiring, timer 440 may invoke an interrupt or initiate a call via operating system 80. A display server D100 may include more than one such timer configured to indicate failure of various hardware and software components of a system including display server D100.

In some applications, it may be desirable or even required to perform a display context switch periodically. In an air traffic control application, for example, an operator may be required to maintain familiarity with a fallback system by using it four or five hours a week. In such a case, a display context switch to the server program 200 of the fallback application may be initiated by the operator, by a supervisor (e.g. via remote network command), or by an automatic scheduler or timer.

Server programs 200 may compete for system resources such as memory, processor cycles, bus access, disk access, etc. Accordingly, it may be desirable to limit the amount of a resource that a server program 200 may allocate or demand, to avoid starvation of other applications such as other server programs. Such control may be especially desirable in an application in which maintaining uptime is important.

Regions of local memory 330 (for example, memory pages) may be allocated to one server program or the other prior to processing of drawing requests (e.g. during system initialization). Pre-allocation of memory regions in such manner may help to avoid a runtime problem that a server program 200 is using too much of the graphics memory.

During runtime, a server program 200 may request allocations of system memory. For example, a request by a client to create a drawable may cause the server program 200 to request an allocation of memory. Excessive memory allocation by one application may lead to starvation of others and/or to system instability. For example, a flaw in a client or server program may cause the server program to repeatedly request additional memory allocations without deallocating memory no longer in use.

It may be desirable to limit the amount of a resource that may be allocated by a server program 200 at one time and/or to limit the total amount of the resource that may be allocated by a server program 200. Display server D100 may be implemented to include a routine to alter video signal S30 and/or to issue a display context switch command when the limit is exceeded or a request to exceed the limit is received. Such a routine may be included in the server program 200 and/or in a window manager, DLL, device driver, or daemon. For example, display server D100 may include a routine to keep track of how much memory a server program 200 has allocated and to refuse allocation requests and indicate an error once a threshold has been reached. In some cases, a routine to monitor resource usage may be configured to receive status reports from the resource (e.g. via operating system 80).

Allocation of system memory among the various user processes is typically handled by an operating system of the display server, which allocates portions of system memory for the exclusive use of each server program 200. From time to time, a server program 200 may request an additional allocation of system memory. A server program 200 may request additional memory for storage of an off-screen pixmap, for example, or in order to accommodate a command to increase the size of a window.

System memory is a finite resource, and it is possible for a display server to fail because no system memory is available to satisfy a critical need. A user process such as a server program may cause such a failure by repeatedly requesting memory allocations while neglecting to deallocate memory that it is no longer using. In order to prevent one or more of the server programs 200 from causing such a failure of the display server, it may be desirable to limit the amount of system memory that may be allocated to a server program 200.

Display server D100 may be implemented such that operating system 80 enforces a predetermined limit on the “process size” of a server program 200, or the total amount of system memory that is currently reserved for the server program's use. In one example, initialization of a server program 200 includes a call to operating system 80 to establish a limit on the process size. In a UNIX or Linux system, for example, such a limit may be established using the “ulimit” command. The process size limit may be specified in a configuration file of the server program. Different instances of server program 200 may be initialized according to the same configuration file, or different files (possibly with different limits) may be used for different instances of server program 200.

During execution, if the server program 200 requests a memory allocation that would cause the process size to exceed its limit, the operating system returns an error to the server program. This limit error is not the same as an allocation error which indicates that the requested amount of system memory is not available to any user process. In the case of a limit error, the amount of memory requested may actually be available, and the error simply indicates that fulfilling the request would violate a predetermined limit. Such an error is not necessarily fatal to the server program, and display server D100 may be implemented to handle a limit error in any of several different ways.

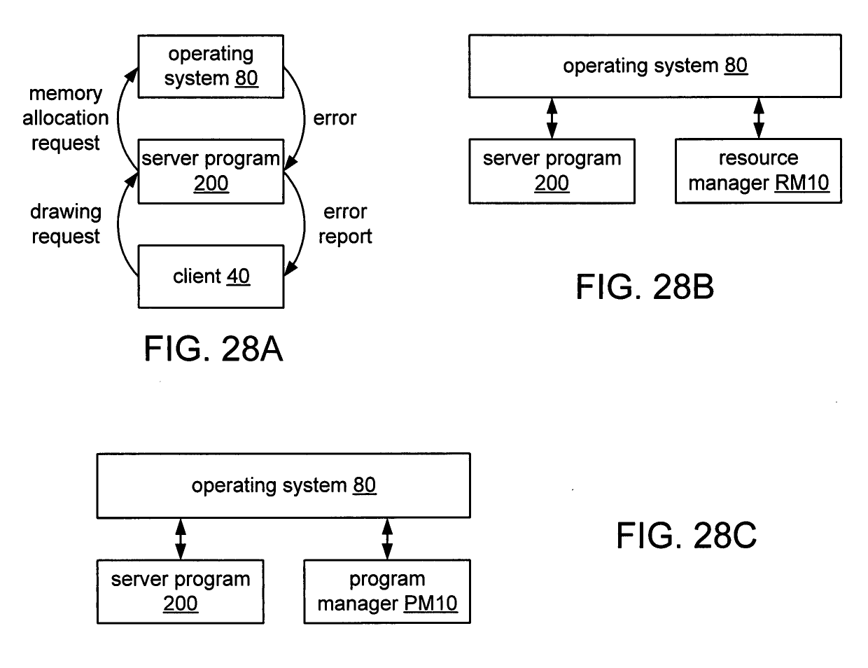

In some cases, the server program is configured to report a memory limit error to the client, which decides how to handle the error. FIG. 28A illustrates one example of such a sequence of events. The client may choose to ignore the error and allow the server program to continue execution without the requested allocation. Alternatively, the client may instruct the server program 200 to call a memory clean-up routine and then to resubmit the memory allocation request. In one such example, the memory clean-up routine is configured to deallocate temporary image storage, such as pixmaps. After such a memory clean-up routine is performed, the server program may prompt the client to redraw any temporary images that are still being used. The client may also instruct the server program to terminate if the memory allocation request is refused again, or if two such requests are refused within some period of time (e.g. five minutes).

In another case, display server D100 is implemented to allow the client to override the limit error. For example, server program 200 may be configured such that the client may instruct the operating system 80 (via server program 200) to increase the allocation limit. A routine to carry out such a client command could be included in an extension layer of server program 200. The client may then instruct the server program to repeat the memory allocation request. Such an option may be disfavored, however, as it could allow a faulty client to override a protection mechanism of display server D100.

In a further case, upon receiving a memory limit error report, the client commands server program 200 to exit. The client may first command the server program to change the display context state of display server D100 if the server program is visible, and server program 200 may initiate the change before terminating. Alternatively, the client may instruct server program 200 to terminate immediately, in which case another element of display server D100 (e.g., a program manager as described herein) may be configured to detect the termination as described herein and initiate a display context switch if appropriate.

In other cases, server program 200 is configured to handle the memory limit error. For example, the server program may be configured to perform a display context switch if it is visible and/or to exit upon such an error. Alternatively, the server program may be configured to execute a memory clean-up routine as described above, to prompt the client to redraw any temporary images still in use, and to repeat the memory allocation request. In this case, the server program may also be configured to exit if the request results in another limit error.

Another option is to implement display server D100 such that all memory allocation errors are fatal. One way to implement this option is to vector all calls to the function “xalloc” to the function “xfnalloc” instead. A memory limit error resulting from a call to “xfnalloc” will cause the calling process (i.e. the server program) to terminate. In this case, another element of display server D100 (e.g., a program manager) may be configured to detect the termination as described herein and initiate a display context switch if appropriate.

Display server D100 may be implemented to handle allocation of one or more other finite resources, such as disk space, in a similar fashion. For example, operating system 80 may be configured to establish a disk quota for each of one or more server programs (e.g., according to a corresponding configuration file). Upon receiving an error resulting from an attempt to increase the allocated disk space beyond the quota, the server program may report the error to a client or handle it locally (e.g., by performing a disk clean-up routine, initiating a display context switch, or terminating).

It may be desirable to protect against an overload of a CPU of display server D100 and/or of a processing unit of graphics controller G10. For example, display server D100 may be configured to monitor a use of processor cycles, such as cycles of a CPU of the display server and/or processing unit 310, and to perform a display context switch when the visible server program reaches or exceeds a permissible use threshold. In case of an impending overload, display server D100 may also be configured to limit, pause, or terminate the server program responsible. Measuring metrics of a processing unit and keeping track of its use by each server program 200 may be viewed as a load balancing problem.

In a typical display server, CPU cycles are a finite resource, and it may be desired to limit the use of this resource by any one server program. In some cases, a server program 200 is implemented to monitor its own CPU use and to terminate when its CPU use meets a threshold value (alternatively, when its CPU use exceeds a threshold value). Such a server program may be configured to perform this monitoring task by setting up an asynchronous timer, which typically includes executing one or more calls to the operating system that establish a timer interval (e.g. ten or 100 milliseconds) and register a routine with the kernel as the timer handler. When the timer expires (e.g. when a particular time-of-day is reached), the operating system interrupts the server program to execute the timer handler routine and resets the timer.

In one example, the timer handler routine is configured to determine an average CPU use by the server program (e.g., over some brief interval) and to compare this average to a threshold value. In a UNIX system, the routine may be configured to determine the average CPU use by calling one of the system utilities “top” or “ps” using the process ID of the server program. If the routine determines that the average CPU use meets or exceeds the threshold value, it terminates the server program. In a UNIX system, terminating a server program may be accomplished by making a system call such as “kill-15” or “kill-9” using the process ID of the server program, or “pkill” using the process name of the server program.

It may be desirable to minimize the changes needed to modify an existing server program into a server program 200. Instead of modifying a server program to monitor its own CPU use, for example, it may be desirable to implement display server D100 to include a separate user process that monitors CPU use of one or more server programs. Such a user process (called a “resource manager” herein) may be implemented to determine average CPU use of each of one or more server programs (e.g., by calling a utility such as “top” or “ps”) and to detect overuse by comparing the average CPU use to a threshold value. In one example, the resource manager is otherwise dormant, and it configures a timer to wake it up periodically to perform these tasks (e.g., according to a timer interval of ten or 100 milliseconds). In another example, the resource manager is otherwise active, and it configures the timer to interrupt it. Upon detecting a CPU overuse, the resource manager issues a system call to terminate the offending server program. FIG. 28B shows a block diagram of a resource manager RM10 in monitoring relationship with a server program 200 via operating system 80.

A resource manager may also be used to monitor use of other finite resources. For example, a resource manager may be configured to detect when a server program's use of memory and/or disk space becomes close to the respective allocation limit. Such a resource manager may configured to periodically determine the server program's current use of the resource (e.g., by a timer-driven call to a function such as “top” or “ps” as described above) and to detect potential overuse by comparing the current use value to a threshold value (e.g., a percentage of the maximum permitted allocation, such as 75%). In one such case, upon detecting a potential overuse, the resource manager prompts the server program to initiate execution of a clean-up routine for the corresponding resource. Alternatively, display server D100 may be implemented to include a user process separate from the resource manager that is configured to detect potential overuse in a manner as described above. Such a preventative measure may avoid an eventual need to terminate the server program.

Loading of processing unit 310 may be indicated by the number or volume of rendering commands each server program 200 sends to graphics controller G10. As current GPUs are typically so fast that the rendering commands are executed faster than they can be delivered, overuse of processing unit 310 by one of the server programs 200 is not likely to be a problem, especially in a relatively nonintensive graphics application such as air traffic control.

FIG. 27B shows a block diagram of an implementation D250 of display server D200 that includes an implementation 819 of command detector 810. In this example, command detector 819 is configured to initiate a display context switch according to information from or relating to an element or resource 450 of the display server. For example, command detector 819 may be configured to initiate a display context switch when system memory allocated to the visible server program reaches a threshold, when the visible server program issues commands that correspond to a number of GPU cycles over a predetermined time period that is higher than a threshold, or upon an error report from the operating system. Command detector 819 may be implemented in software and/or in firmware. Display server D100 may also be configured to trigger a displayed indication of the error condition (e.g. by calling a routine of the visible server program), while in other implementations, display server D100 may be configured to display an indication of the error without switching the display context.

Display server D100 may be configured to verify that graphics controller G10 is executing rendering commands as expected by, for example, monitoring command buffer use. Failure of the graphics controller G10 to consume rendering commands at an expected rate may indicate a problem with the rendering context, such as an infinite loop in the command queue. In such an implementation, the display server may be configured to force a rendering context switch if use of a buffer stops or drops below a threshold.

A server program may fail for any of several reasons. The operating system may terminate a server program because of a memory allocation error as described above, or because of a violation such as a segmentation fault. A server program may also terminate in response to an error from the operating system, such as an error relating to a backup condition of a DMA buffer (e.g. a graphics FIFO buffer timeout error), or according to a client command. It may be desirable for a display server D100 to include a user process that is configured to detect such a failure and to initiate a display context switch and/or a restart of the failed server program. Such a process is called a “program manager” herein.

In one example, a program manager is configured to establish a socket connection or other dedicated communications channel with each of one or more server programs via operating system 80. When one of these server programs fails, the program manager is notified by receiving an error on the corresponding socket connection. The program manager may be configured to respond to the failure by initiating a switch to a display context corresponding to another server program (e.g., by issuing a display context switch command). Additionally or alternatively, the program manager may be configured to initiate a restart of the failed server program. For example, the program manager may instruct the operating system to run the server program (e.g., to open a corresponding executable file) or to open a batch file that includes such a command. FIG. 28C shows a block diagram of a program manager PM10 in monitoring relationship with a server program 200 via operating system 80.

In a typical implementation of display server D100, each server program is associated with a particular display identifier. In a system using a version of the X protocol, for example, the server program corresponding to one display context may be associated with the display identifier “machine_name:0”, while the server program corresponding to another display context is associated with the display identifier “machine_name:1”, where the character string “machine_name” identifies display server D100 on the network. In an implementation of display server D100 that uses another display communications protocol, each server program may be associated with a similar display identifier or handle.

It may be desirable for a failed server program to restart using the same display identifier, such that a client may reestablish a connection to it. In one example, a client 40 responds to a closed connection by periodically attempting to communicate via the corresponding display identifier. In a system using a version of the X protocol, for example, upon receiving an error on the corresponding socket connection, the client may periodically issue an “XOpenDisplay” request directed to the display identifier. The client may issue such a request (e.g. in intervals of five seconds, thirty seconds, etc.) until the server program responds or until a maximum number of attempts have been made.

Display server D100 may include a separate resource manager for each monitored resource, or one resource manager may be configured to monitor the use of multiple resources. Likewise, display server D100 may include an individual resource manager for each of two or more server programs, or one resource manager may be configured to monitor use of a resource by more than one server program. Similarly, display server D100 may include a separate program manager for each of two or more server programs, or one program manager may be configured to manage more than one server program. In any of these cases, it is also possible to integrate either of a resource manager and a program manager with each other and/or with another user process such as an input manager as described herein.

Display context selector 820 is configured to modify the display context state of display server D200 (e.g. to select which of the server programs 200 is visible) according to display context signal S50. For example, display context selector 820 may be configured to select a display context state of graphics controller G10 by indicating which of two or more display buffers are scanned out to produce video signal S30.

Display context selector 820 may include a register of graphics controller G10 (e.g. of processing unit 310) or another storage element configured to store a value such as a location of a selected display buffer. Display context signal S50 may include the value to be stored to selector 820. Alternatively, display context signal S50 may otherwise indicate the selected display context state. In one such example, signal S50 has a binary value indicating a corresponding one of two display context states, and display context selector 820 includes values (e.g. the starting addresses of display buffers) corresponding to each of the two display context states. In this case, display context selector 820 is configured to store (e.g. to a register of processing unit 310) the value corresponding to the display context state indicated by signal S50.

Some implementations of display context selector 820 may include more than one register. For example, display context selector 820 may include a register to store location information of a display buffer and a register to store corresponding formatting information for the display buffer. For an implementation in which display server D100 produces more than one video signal (such as a dual-head arrangement), display context selector 820 may be configured to store a different value for each video signal, such as a starting location of the corresponding display buffer. The different values may be stored according to a single display context selection (e.g. a single display context switch command or display context signal) or according to independent selections.

In addition to a register or other storage element, display context selector 820 may be implemented to include one or more routines. In one example, command detector 810 is configured to assert display context signal S50 as an interrupt request line of the CPU or of processing unit 310, and selector 820 includes a corresponding interrupt service routine configured to write the location of the selected display buffer to a register of processing unit 310. In other examples, such a routine may be implemented at the operating-system or user-process level of the system architecture.

In some implementations of display server D100, detection and selection of the display context state are performed separately from the server programs 200. In other implementations, a server program 200 may be implemented to include one or both of a command detector 810 and a routine of display context selector 820. For example, a visible server program 200 may be configured to detect a display context switch command among a stream of input information received from one or more input devices 50 and to output a corresponding display context signal S50 to cause another server program 200 to become visible. Alternatively, a nonvisible server program 200 may be configured to detect, among the input stream, a display context switch command to become visible and to output a corresponding display context signal S50. Similarly, a visible or nonvisible server program 200 may be configured to perform a display context state selection (e.g. by writing a particular value to a register, or by accessing a particular write location) according to display context signal S50.

In a typical implementation of display server D100, each server program 200 is not aware of any other server program. In other implementations, however, two or more server programs 200 may be configured to communicate regarding changes to the display context state. For example, server programs 200 may be configured such that the currently visible server program 200 detects a display context switch command and outputs display context signal S50, and the selected server program 200 performs the corresponding display context state selection. Alternatively, server programs 200 may be configured such that the selected server program 200 detects the display context switch command and outputs display context signal S50, and the currently visible server program 200 performs the corresponding display context state selection. In other cases, a server program 200 may be configured such that it both detects the display context switch command and performs the corresponding display context state selection. In case of failure of the currently visible server program 200, for example, it may be desirable for the selected nonvisible server program 200 to detect the display context switch command and to perform the corresponding display context state selection.

A display context switch may be practically instantaneous, although in some cases, side effects of the hardware reconfiguration may be visible as a disruption in video signal S30. For example, switching to a context having a different format and/or screen resolution may involve restarting and/or resynchronizing one or more video clocks of display interface 320 and/or graphics controller G10. A temporary loss of synchronization may result, causing a discontinuity in a timing component of video signal S30. For example, the periodic signal that indicates the frame boundaries of video signal S30 may lose its periodicity during the frames before and/or after the display context switch, in that the boundaries between frames may be unequally spaced. This loss of periodicity may cause a temporary but highly visible disruption of the sequence of video frames having an appearance similar to that of a flicker or other disruption as seen upon changing the channel in a digital cable TV system. Nevertheless, the display context switch may be expected to be at least as fast as, and typically faster than, a mechanical KVM switch.

It is desirable to reduce the screen disruption that may be associated with a display context switch. Some KVM switches are configured to mask the loss of synchronization that occurs upon switching a video signal by blanking the video signal for a period of up to two seconds. Display server D100 may be implemented to mask a discontinuity resulting from a display context switch in a similar fashion (e.g. by configuring graphics controller G10 to temporarily blank video signal S30 upon performing a display context switch). However, such an approach is not optimal, and it is preferable to implement display server D100 such that the disruption is avoided rather than masked.

Some implementations of display server D100 are configured to perform an instantaneous display context switch (i.e. with an absence of disruption such as flicker in video signal S30). For example, a loss of synchronization during switching may be avoided in a case where server programs 200a,b are configured to draw images having the same output resolution. In such case, the display context switch may be performed by programming the scanout of the next frame to begin at a different starting address in memory (e.g. by writing a different region offset value to a register of display context selector 820) without any change in the video timing. For example, scanout of the next video frame may be configured to begin at the starting address of a different display buffer that stores a screen image having the same attributes such as resolution and color depth. In such manner, video clock restarting and re-synchronization may be avoided, and the timing of the frame boundaries of video signal S30 may remain constant (e.g. a vertical synchronization signal of video signal S30 may remain substantially periodic) across the frames before and after the display context switch.

A drawing request as produced by a client 40 may be based on information that the client receives from other sources, such as sensors and/or data servers. For example, a client 40 may receive data such as geographical maps; information regarding current weather conditions, locations of vehicles, etc.; and/or other characteristics or data corresponding to people, objects, or coordinates. Such information may be received over a network, and in some cases the client 40 may transmit drawing requests based on such information into the same network.

A typical display server includes one or more serial or parallel input ports, such as PS/2 and/or USB ports. Input devices connected to such ports may include data entry, pointing, and/or scrolling devices such as one or more keyboards, mice, touchscreens, stylus or touch pens, and the like. The display server receives information from the input devices in the form of input events, which may include actuations of switches (such as keys or mouse buttons) and movements of a mouse or other pointing or scrolling device. (An input port may also be configured to receive information from an input device over a wireless connection, such as a Bluetooth™ or ultra-wideband (UWB) link.) The operating system handles the input events, usually via routines such as device drivers, and the server program receives the corresponding input information from the operating system and forwards it to a client. For example, the server program may transmit the input information to the client as one or more X protocol messages.

In one typical event handling sequence, an input event generates a hardware interrupt. A kernel driver is called to service the interrupt, and it issues a message to a user process (for example, the server program) that is waiting for input from that device. Some operating systems, such as versions of Microsoft Windows, include components called “services” that provide a similar interface between user processes and devices or device drivers and are analogous to kernel drivers as described herein.

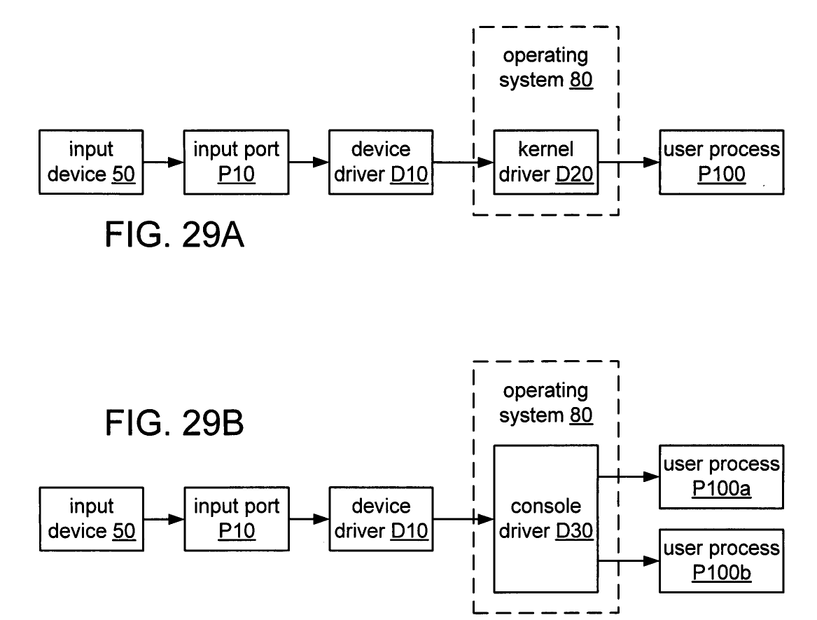

FIG. 29A shows one example of a path by which a user process P100 such as a server program may receive input information from an input device 50. In one typical initialization sequence, a user process opens a particular input device by specifying the device in a call to the operating system kernel. The kernel then opens the kernel driver for that device, and the kernel driver calls the appropriate device driver. The user process may make additional calls to configure the operating system to send it a message when input is pending on the device. Other initialization sequences are also possible, and a driver may be integrated into the operating system or into a basic input/output system (BIOS) of the display server or may be implemented as a separable module configured to interface with the BIOS and/or operating system.

In a similar manner, it may be desirable to support interaction between an operator of a display server according to an embodiment and one or more clients 40. For example, the operator may interact with a client via one or more input devices 50 connected to the display server. As in the case of a typical display server, an operating system 80 of a display server according to an embodiment may be configured to handle input events received from input devices via input ports (such as PS/2 and/or USB ports), and server programs 200 may be configured to transmit input information to one or more clients 40 (e.g. as X protocol messages). As discussed above, display server 200 may also be configured to detect a display context switch command received via such an input device.

In some arrangements, a kernel driver (or similar service) will allow only one user process to open an input device 50. In these cases, the kernel driver may return a busy error to another user process requesting the device. Other kernel drivers may be configured to provide more than one access point such that multiple user processes may be attached to the same input device 50. FIG. 29B shows an example of a path that includes such a kernel driver, a console driver that supports several virtual terminals. In this example, each user process P100 attaches to a respective virtual terminal, and console driver D30 is configured to activate and deactivate the virtual terminals to provide information from input device 50 to different user processes at different times. A user process such as a server program 200 may be configured to send a request to the kernel to activate or deactivate its virtual terminal upon detecting a display context switch command. Alternatively, the user process may be configured to send such a request upon receiving a command from another element of display server D100, such as an input manager as described herein.

A display server may include more than one device driver to handle input events from different input devices. For example, an input device may be serviced by a console driver or similar component that allows more than one user process to be attached to the device, at least at different times. In at least some cases, however (for example, for a particular operating system), such a driver may only be available to support a keyboard. For other devices or in other configurations, when it is desired to attach an input device to a different user process (e.g., a server program that has just become or is becoming visible), a user process may reopen an input device instead of switching an existing device connection to a different user process. For example, a user process (e.g. an input manager or a server program) may reopen a mouse driver in such a case. Upon switching or reopening a pointing device such as a mouse, it may be desirable to place the cursor in a default position, such as in the middle of the display, or to restore it to a last recorded position within the particular display context.

In a display server according to an embodiment, it may be desired to control how input events are distributed to and/or handled by server programs 200. For example, it may be desired to avoid sending input information to a client that is currently nonvisible, as this information may not be correlated with the current state of the client and may produce undesirable consequences if processed by the client. As the display context state switches from one server program 200 to another, therefore, it may be desirable to change the arrangement for handling input events accordingly. For example, both (or all) clients 40 may execute normally in terms of producing drawing requests, with only one of the clients receiving operator input at any one time. Likewise, both (or all) server programs 200 may execute normally in terms of receiving drawing requests and producing rendering commands, with only one of the server programs reporting input events to a client at any one time.

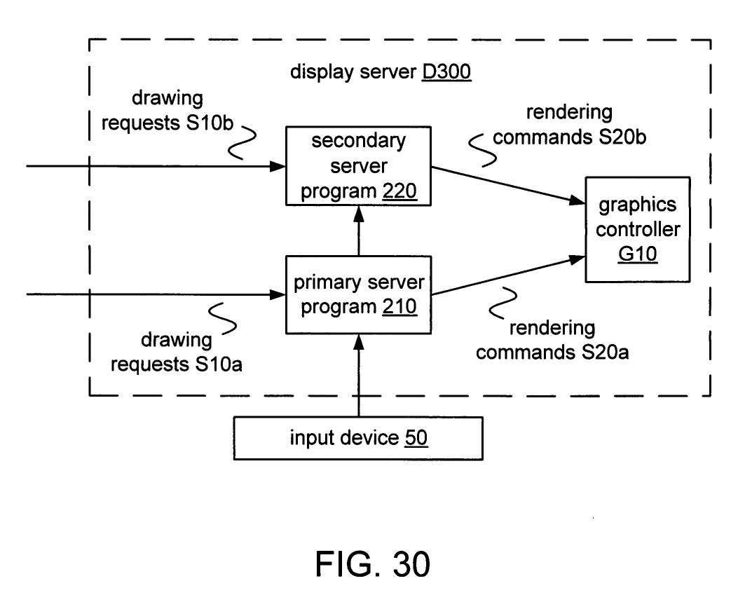

In one approach, a display server according to an embodiment is configured to include a primary server program 210 and a secondary server program 220, each being implementations of a server program 200 as described herein. FIG. 30 shows a block diagram of a display server D300 according to one such embodiment. Primary server program 210 is configured to open one or more input devices 50 and to receive input information from them. For example, primary server program 210 may be configured to open each device 50 by opening a driver or by attaching to an access point in an operating system. In some implementations, secondary server program 220 is a conventional server program as is known or may be developed, and primary server program 210 is derived from such a server program by modifying the DDX layer and/or adding one or more extension routines to perform tasks as described herein.

If primary server program 210 determines that it is currently visible, then it forwards the input information to one or more corresponding clients (e.g. as one or more X protocol messages). In this case, secondary server program 220 may be unaware that the input events have occurred. Primary server program 210 may be configured to determine the current display context state with reference to a display context state indicator, which is updated upon a display context switch and may be implemented as a software flag within or outside of primary server program 210.

If primary server program 210 determines that secondary server program 220 is currently visible, then it forwards the input information to secondary server program 220, which may be configured to process the information just as if it was received directly. For example, secondary server program 220 may be configured to forward the input information to one or more corresponding clients (e.g. as one or more X protocol messages).

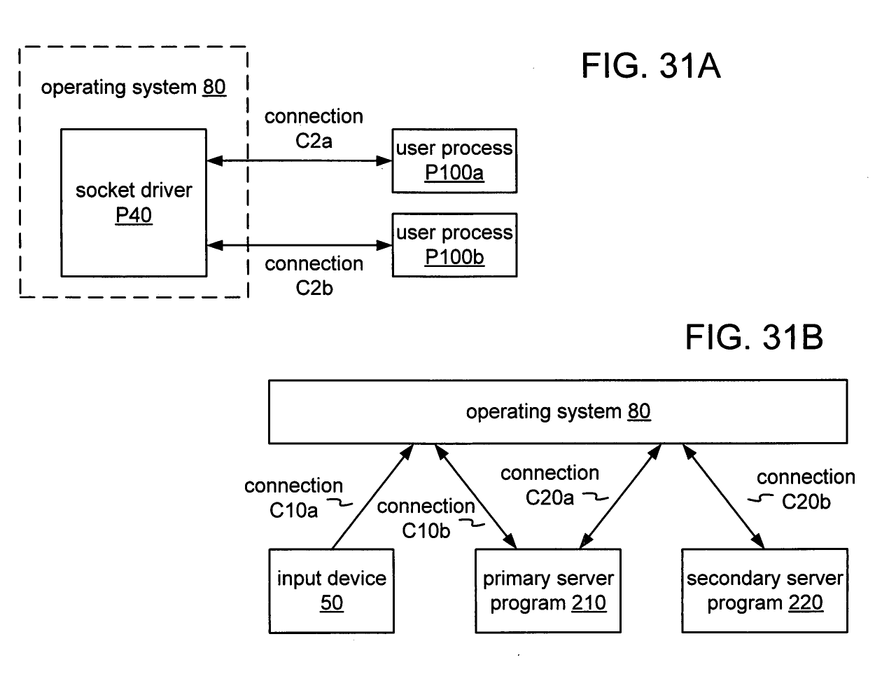

Communication of input information from primary server program 210 to secondary server program 220 may be implemented via operating system 80. For example, a dedicated communication channel such as a socket may be established between the server programs. FIG. 31A shows one example of a socket driver D40 of operating system 80 that supports communication between two user processes P100a,b (e.g. primary server program 210 and secondary server program 220). In one typical initialization sequence, user process P100a is the first of the two processes to execute, and it opens a listening socket. When user process P100b starts up, it signals this listening socket, and the two user processes execute handshaking operations with each other to establish a communication socket (including connections C2a,b) between them.

FIG. 31B shows an example of a virtual path configured to carry input information from an input device 50 to primary server program 210 and secondary server program 220. Operating system 80 is configured to receive input information from input device 50 over connection C10a. When input information from device 50 is pending, operating system 80 sends a message to primary server 210 over connection C10b. Primary server 210 then issues a call to operating system 80 over connection C10b to retrieve the pending input. Connections C10a and C10b may be implemented according to a model as shown in FIG. 29A or FIG. 29B.

If primary server program 210 is currently visible (e.g. as indicated by display context state indicator), then primary server program 210 sends the input information to a client 40. If primary server program 210 determines that secondary server program 220 is currently visible instead, then primary server program 210 forwards the input information to secondary server program 220 via connections S20a and S20b, which may be implemented according to a socket model as shown in FIG. 31A.

Connections C20a and C20b may be used to transfer input information and/or other information between the server programs, such as status information or requests (e.g. a display context switch command, or a command to take over or to release the handling of input information). The server programs may be configured to write to and receive information from such connections via calls to operating system 80. In one operating sequence, primary server program 210 executes a call to send the input information to operating system 80, operating system 80 sends a message to secondary server program 220 indicating that input is pending, and secondary server program 220 executes a call to operating system 80 to obtain the input information. In another example, operating system 80 receives only a notification of pending input information from primary server program 210, and operating system 80 requests the input information from primary server program 210 after receiving the corresponding request from secondary server program 220.

In another implementation, primary server program 210 is configured to direct operating system 80 to send the input information to secondary server program 220 (e.g. via connection C20b) when secondary server program 220 is visible. Primary server program 210 may be implemented to handle input information from different input devices in different manners as described above.

In the event that primary server program 210 fails, secondary server program 220 may be aware of the failure. For example, operating system 80 may be configured to send an error condition report to secondary server program over connection C20b upon failure of primary server program 210. In some implementations of display server 200, failure of primary server program 210 may prevent secondary server program 220 from receiving input, and secondary server program 220 may be configured to respond to such an event by initiating a display context switch, terminating, and/or initiating a reboot of the display server. In another implementation, operating system 80 is configured to close the input device or devices upon failure of primary server program 210, and secondary server program 220 is configured to take over as primary input handler by reopening the input device or devices and possibly restarting primary server program 210 in a secondary role. For a case in which the driver handling an input device supports multiple access points (e.g. a console driver handling a keyboard), operating system 80 and/or secondary server program 220 may be configured to close an access point (e.g. a virtual terminal) of primary server program 210 upon failure of the primary server program and to activate an access point of secondary server program 220.

In an application of display server D300, a client may send a display context switch command to primary server program 210. A backup client may also send a display context switch command to secondary server program 220, possibly in response to a message from a primary client (e.g. a report that a primary radar feed is down). In some systems, it may be desired to perform a display context switch only in response to a request from a client. Display server D300 may be implemented such that the server programs communicate with one another (e.g. via connections C20a,b) only to initiate a display context switch.

FIG. 32 shows an example of an installation including an implementation D310 of display server D300. Display server D310 includes a network interface 100 as described herein. In this redundant installation, primary server program 210 is configured to receive drawing requests from primary application 42a over primary network N100 (e.g. a LAN), and secondary server program 220 is configured to receive drawing requests from backup application 42b over backup network N200. Primary application 42a and backup application 42b are related instances of a client application 40 as described herein. In this particular example, the client applications 42a,b are configured to send drawing requests based on information received from corresponding redundant radar feeds RD10a,b, which may indicate locations of vehicles such as aircraft.

Clients 42 may be applications executing on machines located somewhere else (e.g. in the building) and communicating with the server programs 210, 220 over one or more LANs. If the LAN breaks, it can be detected and an automatic display context switch may be performed. Failures of other system elements, such as the radar feed RD10a for the primary client application, can be detected by the processor executing the primary application 42a, which may then send a command to the primary server program 210 to perform a display context switch to the backup system. Other deployments of such an installation may include one or more instances of implementations of display server D100, D200, and/or D300 as described herein. Such a system having redundancy of networks, application servers, and data servers may also be applied in other situations.

It may be desired to perform operations of distributing input information among server programs 200 separately from the server programs themselves. For example, it may be desired to avoid the need to modify an existing server program to perform the operations of a primary server program as described above, to obtain a system operation that is robust to failure of any of the server programs, to support detection of a display context switch command even if the visible server program has failed, and/or to simplify redirection of events from multiple input devices upon a display context switch.

In another approach, a display server according to an embodiment includes a user process, separate from the server programs, that is configured to manage input information received from input devices 50. Such a user process is called an “input manager” herein. An input manager may be implemented in the kernel or as an application (in a window manager, for example, or as a relatively small process such as a daemon, service, or terminate-and-stay-resident (TSR) program). It is also possible to implement an input manager as a very low-level (e.g. kernel mode) routine that is configured to selectively attach one among several user processes to a particular input device.

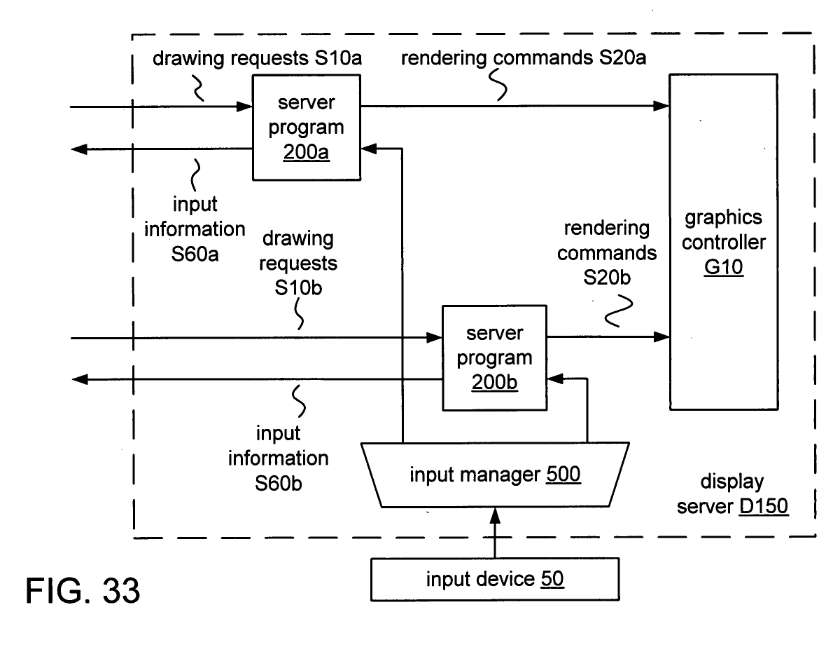

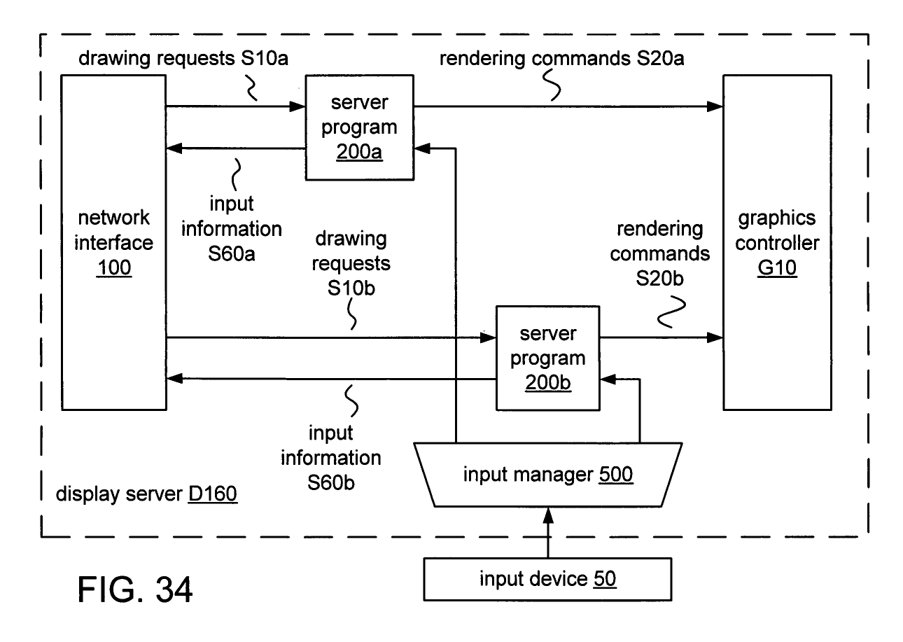

An input manager may be configured to manage input information from several input devices, although it is also possible for a display server to include more than one input manager to handle input events from different input devices. FIG. 33 shows a block diagram of an implementation D150 of display server D100 that includes an input manager 500, and FIG. 34 shows a block diagram of an implementation D160 of display server D150 that also includes network interface 100.

Input manager 500 may be configured to open each of one or more input devices and to receive input information from them (e.g. according to a model as shown in FIG. 29A). Alternatively, the operating system may be configured to provide multiple access points to an input device (e.g. as in the model of FIG. 29B), and input manager 500 may be configured to attach to such an access point (for example, a virtual terminal). An input manager 500 may also be configured to receive input information from one or more devices according to a model as shown in FIG. 29A, and to receive input information from one or more other devices according to a model as shown in FIG. 29B.

Input manager 500 is configured to notify one or more server programs 200 of pending input. For example, input manager 500 may be configured to communicate with each of the server programs over a respective socket connection. In some implementations, input manager 500 is configured to receive the input information from operating system 80, to store it to a buffer, and to forward it to one or more server programs. In other implementations, input manager 500 is configured to store the input information to a buffer that is also accessible to one or more server programs. In such case, the server program(s) may receive a notification of pending input that indicates where the input information can be found.

As described above, a server program 200 may be configured to forward the input information to a client 40 according to a protocol such as the X protocol. In some cases, an input event such as a display context switch command may be processed within the display server as discussed herein (whether by a server program or by another element of the display server) without being forwarded to a client.

It may be desired for at least two server programs 200 to receive the input information, with each one being configured to forward the information to a client only if it is currently visible. In such case, each server program may include or have access to a display context state indicator as described above so that it may determine whether it is currently visible. For an implementation in which the server programs conduct display context switch command detection, receipt of the input information by more than one server program may help to ensure that a display context switch command will be detected even if the visible server program has failed.

In other cases, it may be desired for only the visible server program to receive input events. In such cases, the display server may include, in the input path between and including the interrupt service routine to the input manager, another element that is configured to detect a hot-key or other display context switch command among the input information (e.g. a command detector 810 as described herein).

In some implementations, input manager 500 is not aware of the display context and may be configured to send an indication of pending input to visible and nonvisible server programs 200. In other implementations, input manager 500 is aware of the display context and may be configured to send an indication of pending input only to the server program 200 that is currently visible. In these cases, input manager 500 may be configured to include or access a display context state indicator as described above that indicates which server program 200 is currently visible. This indicator may be internal or external to input manager 500 and may be updated (e.g. by a command detector 810) upon a display context switch.

Upon completing initialization of the input device and socket connections, input manager 500 may be configured to become dormant until operating system 80 awakens it with a report of pending input. Input manager 500 may also be awakened to forward communications between server programs that relate to a display context switch. In one such example, upon receiving a command to become visible from a client 40, a server program instructs the visible server program (via input manager 500) to disable its output to the display and then completes the display context switch by enabling its own display output and possibly updating any display context state indicators. Operating system 80 may also awaken input manager 500 in case of failure of a server program. In one such case, input manager 500 is configured to contact another server program to initiate a display context switch.

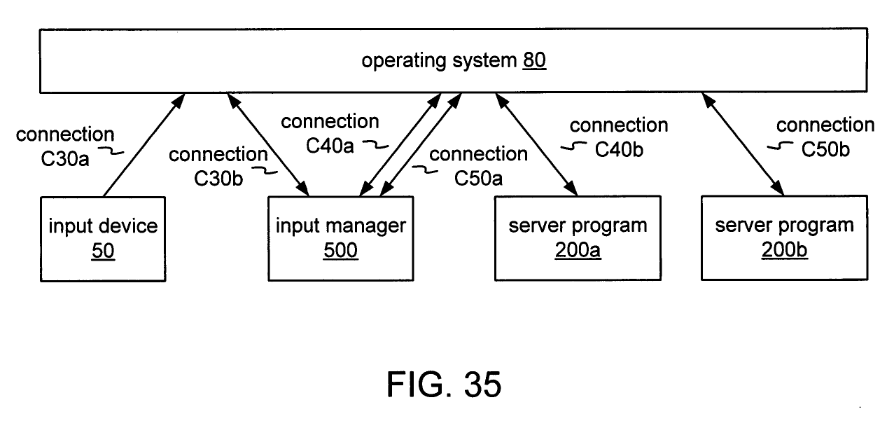

FIG. 35 shows an example of a virtual path configured to carry input information from an input device 50 to server programs 200a,b via input manager 500. Over connection C30a, operating system 80 receives input information from input device 50 (e.g. via an input port). When input information from device 50 is pending, operating system 80 sends a message to input manager 500 over connection C30b. Input manager 500 then issues a call to operating system 80 over connection C30b to retrieve the pending input. Connections C30a and C30b may be implemented according to a model as shown in FIG. 29A or FIG. 29B.

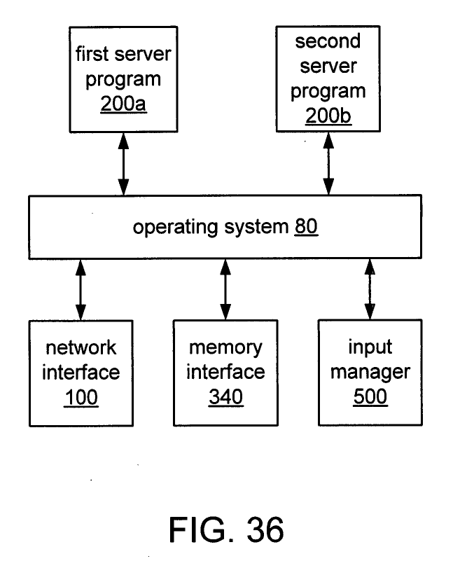

If the display context state indicator shows that server program 200a is currently visible, then input manager 500 forwards the input information via connections S40a and S40b to server program 200a, which may send it to a client. If the display context state indicator shows that server program 200b is currently visible, then input manager 500 forwards the input information via connections S50a and S50b to server program 200b, which may send it to a client. Each connection pair S40a,b and S50a,b may be implemented according to a socket model as shown in FIG. 31A. FIG. 36 shows a diagram of communication among elements of display server D160 via operating system 80.

Other configurations for distributing input information to one or more server programs 200 may also be used. For example, input manager 500 may be configured to forward a notification of pending information, and/or the location from which such information may be retrieved, to the server program. The server program may be configured then to request the information from input manager 500 or to retrieve it from the specified location or another known location (e.g. an input buffer), possibly via another socket connection.

In some implementations, input manager 500 is configured to include command detector 810 and/or a routine of display context selector 820. For example, input manager 500 may be configured to detect a display context switch command (such as a hot-key) and to perform the display context switch. In other cases, input manager 500 is configured to detect a display context switch command but does not have access to the address space of graphics controller G10, such that it issues display context signal S50 to another element, such as a server program, to carry out the display context switch.

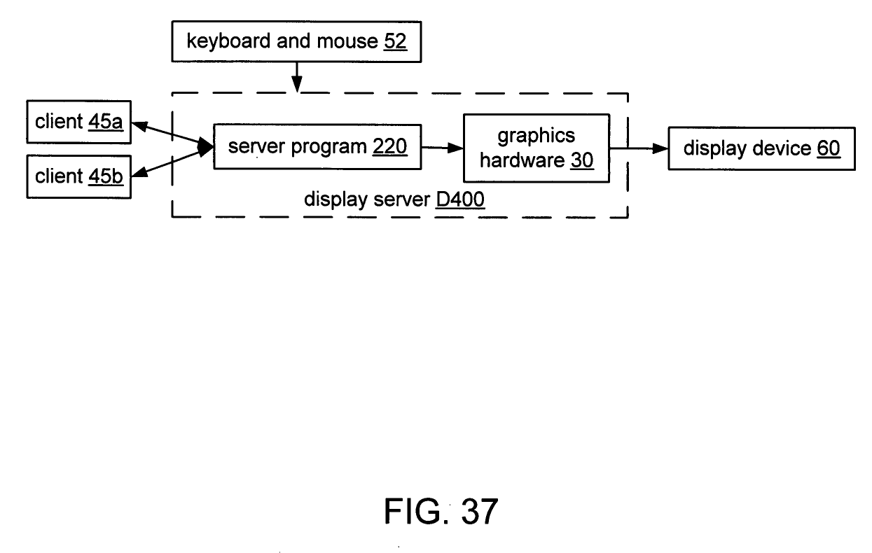

This application discloses implementations of display server D100 in which two or more server programs 200 execute as separate user processes. A display server according to a further embodiment includes a server program configured to switch among more than one display context state. FIG. 37 shows a block diagram of a display server D400 according to an embodiment that includes such a server program 220. Each display context state of server program 220 is associated with a corresponding one of client applications 45a,b, such that the application is visible, and input information from the keyboard and mouse 52 is received by the application, when server program 220 is in that state.

Server program 220 may be implemented by modifying an existing server program with some front-end multiplexing. For example, incoming drawing requests from client 45a may be received through one front end, and incoming drawing requests from client 45b may be received through another front end. For an X server program, such modification may be performed in the DIX layer. It may also be desired to configure server program 220 to store rendered pixel values corresponding to different clients to different corresponding display buffers, and to modify the DDX layer to include a flag indicating the current display buffer.

Each of the clients 45 may be implemented according to a description of clients 40 as set forth herein. In some cases, it may be desired to implement or modify clients 45a, 45b to cooperate with one another, e.g. in terms of performing a display context switch between them. However, such a configuration may not be feasible in a situation where the clients have already been written and tested, and where such changes are not acceptable. Although use of a single multiple-state server program may make it easier to share other hardware of the display server, such an implementation may also have too many restrictions to be practical in some applications. For example, a multiple-state server program may be restricted in applying different characteristics, such as color depth or other drawing attributes, between operations on behalf of each client.

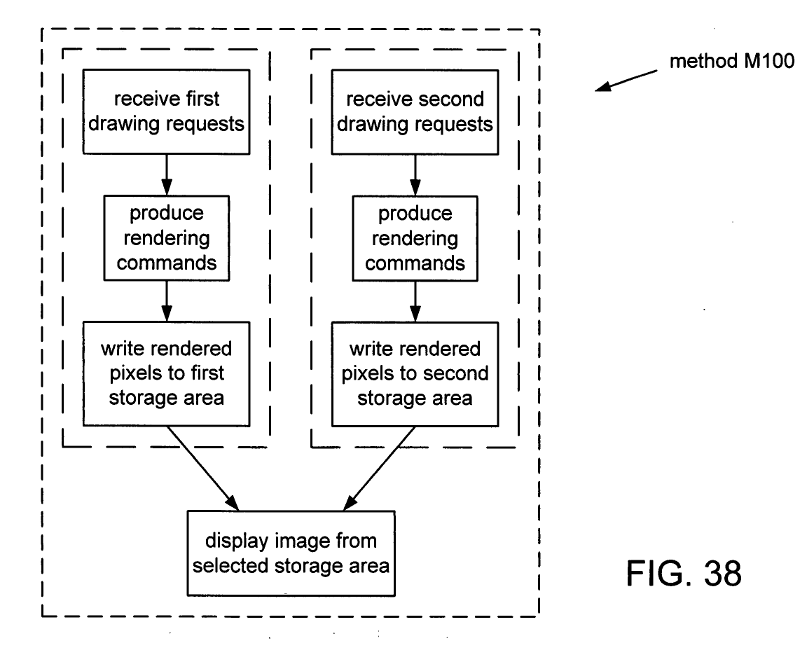

Embodiments also include methods of graphical display, such as a method M100 according to the flowchart of FIG. 38. It is noted that further versions of such methods, as well as additional methods, are expressly disclosed herein by descriptions of the operations of structural embodiments such as display servers and otherwise. Each of these methods may also be tangibly embodied (for example, in one or more data storage media such as semiconductor or other volatile or nonvolatile memory, or magnetic and/or optical media such as a disk) as one or more sets of instructions readable and/or executable by a machine including an array of logic elements (e.g. a processor, microprocessor, microcontroller, or other finite state machine).

The foregoing presentation of the described embodiments is provided to enable any person skilled in the art to make or use the present invention. Various modifications to these embodiments are possible, and the generic principles presented herein may be applied to other embodiments as well. For example, an embodiment may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit.

One or more elements of display server D100 and/or graphics controller G10 may be implemented in whole or in part as one or more sets of instructions executing on one or more fixed or programmable arrays of logic elements (e.g. transistors, gates) such as microprocessors, embedded processors, IP cores, digital signal processors, FPGAs, ASSPs, and ASICs. One or more such elements may also be implemented to have structure in common, such as a processor configured to execute different portions of code corresponding to different elements at different times, or an arrangement of electronic and/or optical devices performing different operations for different elements at different times. Thus, the claims are not intended to be limited to the embodiments shown above but rather are to be accorded the widest scope consistent with the principles and novel features disclosed in any fashion herein.

1. A display server comprising:
a first server program configured to output a first plurality of rendering commands;
a second server program configured to execute as a user process separate from the first server program and to output a second plurality of rendering commands separate from the first plurality of rendering commands; and
a processing unit configured (A) to output, over a first period and according to rendering commands of the first plurality, values of pixels of a first display frame and (B) to output over a second period overlapping the first period, and according to rendering commands of the second plurality, values of pixels of a second display frame.

2. The display server according to claim 1, said display server comprising a graphics controller that includes said processing unit,
wherein said graphics controller is configured to output a video signal that includes a representation of a selected one among the first and second display frames.

3. The display server according to claim 2, wherein said graphics controller is configured to output the video signal to include (A) a series of video frames and (B) a periodic signal that indicates a frame boundary between each consecutive pair of the series of video frames, and
wherein said graphics controller is configured to output the video signal to include, during a first frame period defined by a consecutive pair of the frame boundaries, a representation of the first display frame, and
wherein said graphics controller is configured to output the video signal to include, during a second frame period defined by a consecutive pair of the frame boundaries and adjacent to the first frame period, a representation of the second display frame, and
wherein the duration of the first frame period is substantially equal to the duration of the second frame period.

4. The display server according to claim 3, wherein the periodic signal is a vertical synchronization signal having a substantially constant period over an interval including the first and second frame periods.

5. The display server according to claim 2, said display server comprising:
a display device configured to display an image according to the video signal; and
a housing configured to hold the display device and to enclose the graphics controller.

6. The display server according to claim 5, wherein said display device includes a liquid crystal display panel.

7. The display server according to claim 1, wherein the first server program is configured to output the first plurality of rendering commands according to a first plurality of drawing requests, and
wherein the second server program is configured to output the second plurality of rendering commands according to a second plurality of drawing requests.

8. The display server according to claim 7, wherein the first plurality of drawing requests describes a plurality of graphics primitives of the first display frame, and
wherein the second plurality of drawing requests describes a plurality of graphics primitives of the second display frame.

9. The display server according to claim 8, wherein the plurality of graphics primitives of the first display frame represent a plurality of objects, and wherein the plurality of graphics primitives of the second display frame also represent the plurality of objects.

10. The display server according to claim 8, wherein the plurality of graphics primitives of the first image indicates current physical positions of each of a plurality of moving objects, and wherein the plurality of graphics primitives of the second image also indicates current physical positions of each of the plurality of moving objects.

11. The display server according to claim 8, wherein the plurality of graphics primitives of the first image indicates current physical positions of each of a plurality of moving vehicles, and wherein the plurality of graphics primitives of the second image also indicates current physical positions of each of the plurality of moving vehicles.

12. The display server according to claim 8, wherein the plurality of graphics primitives of the first image indicates current physical positions of each of a plurality of moving aircraft, and wherein the plurality of graphics primitives of the second image also indicates current physical positions of each of the plurality of moving aircraft.

13. The display server according to claim 1, wherein at least one among the first plurality of rendering commands indicates a first register of the processing unit and an operation to be performed with respect to the first register, and
wherein at least one among the second plurality of rendering commands indicates a second register of the processing unit and an operation to be performed with respect to the second register.

14. The display server according to claim 1, wherein said processing unit is configured to output, according to the first plurality of rendering commands, a first plurality of pixel values that includes the values of pixels of the first display frame, and
wherein said processing unit is configured to output, according to the second plurality of rendering commands, a second plurality of pixel values that includes the values of pixels of the second display frame,
said display server comprising a graphics controller including said processing unit, a first display buffer configured to store pixel values of the first plurality, and a second display buffer configured to store pixel values of the second plurality.

15. The display server according to claim 14, wherein said graphics controller is configured to output a video signal based on pixel values stored in a selected one of the first and second display buffers.

16. The display server according to claim 15, wherein said graphics controller is configured to operate in one among a first display context and a second display context, and
wherein, in the first display context, said graphics controller is configured to output the video signal based on pixel values stored in one among the first and second display buffers, and
wherein, in the second display context, said graphics controller is configured to output the video signal based on pixel values stored in the other among the first and second display buffers.

17. The display server according to claim 16, wherein said display server is configured to change the display context of said graphics controller from one among the first and second display contexts to the other among the first and second display contexts according to a signal received from an input device.

18. The display server according to claim 16, said display server comprising:
an input port configured to receive a signal from an input device; and
a command detector configured to detect that the signal received from the input device indicates a particular keyboard event,
wherein the command detector is configured to initiate a change in the display context of said graphics controller from one among the first and second display contexts to the other among the first and second display contexts upon detecting that the signal received from the input device indicates the particular keyboard event.

19. The display server according to claim 16, wherein said display server is configured to receive a display context switch command arising from an event external to the display server; and
wherein said display server comprises a command detector configured to initiate a change in the display context of said graphics controller from one among the first and second display contexts to the other among the first and second display contexts in response to the display context switch command.

20. The display server according to claim 16, said display server comprising a network interface configured to receive information from a source external to said display server,
wherein said display server is configured to change the display context of said graphics controller from one among the first and second display contexts to the other among the first and second display contexts according to a signal received by said display server via said network interface.

21. The display server according to claim 16, said display server comprising:
a network interface configured to receive a signal from a source external to said display server; and
a command detector configured to detect that the signal received by the network interface includes a display context switch command,
wherein said command detector is configured to initiate a change in the display context of said graphics controller from one among the first and second display contexts to the other among the first and second display contexts upon detecting that the signal received by the network interface includes a display context switch command.

22. The display server according to claim 21, wherein one among said first and second server programs includes said command detector.

23. The display server according to claim 21, wherein said command detector is a user process separate from said first and second server programs.

24. The display server according to claim 16, wherein said graphics controller is configured to output the video signal to include (A) a series of video frames and (B) a periodic signal that indicates a frame boundary between each consecutive pair of the series of video frames, and
wherein, during a first frame period defined by a consecutive pair of the frame boundaries, said graphics controller is configured to operate in one of the first and second display contexts, and
wherein, during a second frame period defined by a consecutive pair of the frame boundaries and adjacent to the first frame period, said graphics controller is configured to operate in the other of the first and second display contexts, and
wherein the duration of the first frame period is substantially equal to the duration of the second frame period.

25. The display server according to claim 24, wherein the periodic signal is a vertical synchronization signal having a substantially constant period across a switch from one among the first and second display contexts to the other among the first and second display contexts.

26. The display server according to claim 16, said display server comprising:
a central processing unit configured to execute the first and second server programs; and
a user process configured to determine an average use of the central processing unit by the first server program,
wherein said user process is configured to initiate a change in the display context of said graphics controller from one among the first and second display contexts to the other among the first and second display context based on a relation between the determined average use and a threshold value.

27. The display server according to claim 16, said display server comprising an operating system,
wherein said first server program is configured to request allocation of an specified amount of memory from said operating system, and
wherein said operating system is configured to return an error to said first server program based on a relation among the specified amount, a process size of said first server program, and a predetermined limit,
wherein said first server program is configured to initiate, in response to the error, a change in the display context of said graphics controller from one among the first and second display contexts to the other among the first and second display context.

28. The display server according to claim 16, said display server comprising a user process configured to initiate a change in the display context of said graphics controller from one among the first and second display contexts to the other among the first and second display contexts upon detecting a termination of one of the first and second server programs.

29. The display server according to claim 16, wherein said processing unit includes a register configured to have one among at least a first state and a second state, and
wherein said graphics controller is configured to operate in the first display context when said register has the first state, and
wherein said graphics controller is configured to operate in the second display context when said register has the second state.

30. The display server according to claim 14, wherein said graphics controller is configured to output the video signal to include (A) a series of video frames and (B) a periodic signal that indicates a frame boundary between each consecutive pair of the series of video frames, and
wherein, during a first frame period defined by a consecutive pair of the frame boundaries, said graphics controller is configured to output the video signal based on pixel values stored in the first display buffer, and
wherein, during a second frame period defined by a consecutive pair of the frame boundaries and adjacent to the first frame period, said graphics controller is configured to output the video signal based on pixel values stored in the second display buffer, and
wherein the duration of the first frame period is substantially equal to the duration of the second frame period.

31. The display server according to claim 30, wherein the periodic signal is a vertical synchronization signal having a substantially constant period over an interval including the first and second frame periods.

32. The display server according to claim 1, said display server comprising a network interface configured to receive information from a source external to said display server,
wherein the first server program is configured to output the first plurality of rendering commands according to a first plurality of drawing requests, received via the network interface, that describes a plurality of graphics primitives of the first display frame.

33. The display server according to claim 32, wherein each among the first plurality of drawing requests is compliant with a version of the X Window System Protocol.

34. The display server according to claim 32, wherein at least one of the first and second server programs is configured to transmit, via the network interface, information received by said display server from an input device.

35. The display server according to claim 32, said network interface comprising:
a first network port configured to receive information from a first network; and
a second network port configured to receive information from a second network separate from the first network,
wherein said first server program is configured to receive the first plurality of drawing requests via the first network port, and
wherein the second server program is configured to output the second plurality of rendering commands according to a second plurality of drawing requests, received via the second network port, that describes a plurality of graphics primitives of the second display frame.

36. The display server according to claim 1, said display server comprising:
an input port configured to receive information from an input device; and
a network interface configured to transmit information into at least one network external to said display server,
wherein, when said graphics controller is in the first display context, said first server program is configured to transmit, via said network interface, information received via said input port, and
wherein, when said graphics controller is in the second display context, said second server program is configured to transmit, via said network interface, information received via said input port.

37. The display server according to claim 1, wherein said processing unit is configured (A) to output, according to rendering commands of the first plurality, values of pixels of a third display frame and (B) to output, according to rendering commands of the second plurality, values of pixels of a fourth display frame,
said display server comprising a graphics controller that includes said processing unit, wherein said graphics controller is configured to output a first video signal that includes a representation of a selected one among the first and second display frames and a second video signal that includes a representation of a selected one among the third and fourth display frames.

38. The display server according to claim 37, wherein said processing unit is configured to output values of pixels of the third display frame during the first period and to output values of pixels of the fourth display frame during the second period.

39. The display server according to claim 1, wherein said processing unit is configured to output, according to the first plurality of rendering commands, a first plurality of pixel values that includes the values of pixels of the first display frame and a third plurality of pixel values, and
wherein said processing unit is configured to output, according to the second plurality of rendering commands, a second plurality of pixel values that includes the values of pixels of the second display frame and a fourth plurality of pixel values,
said display server comprising a graphics controller including said processing unit, a first display buffer configured to store pixel values of the first plurality, a second display buffer configured to store pixel values of the second plurality, a third display buffer configured to store pixel values of the third plurality, and a fourth display buffer configured to store pixel values of the fourth plurality,
wherein said graphics controller is configured to output a first video signal and a second video signal and to operate in one among a first display context and a second display context, and
wherein, in the first display context, said graphics controller is configured to output the first video signal based on pixel values stored in the first display buffer and to output the second video signal based on pixel values stored in the third display buffer, and
wherein, in the second display context, said graphics controller is configured to output the first video signal based on pixel values stored in the second display buffer and to output the second video signal based on pixel values stored in the fourth display buffer.

40. The display server according to claim 1, said display server comprising:
a central processing unit configured to execute the first and second server programs; and
a user process configured to determine an average use of the central processing unit by the first server program.

41. The display server according to claim 40, wherein said user process is configured to compare the determined average use to a threshold value.

42. The display server according to claim 40, wherein said user process is configured to initiate termination of the first server program based on a relation between the determined average use and a threshold value.

43. The display server according to claim 1, said display server comprising an operating system,
wherein said first server program is configured to request allocation of a specified amount of memory from said operating system, and
wherein said operating system is configured to return an error to said first server program based on a relation among the specified amount, a process size of said first server program, and a predetermined limit.

44. The display server according to claim 43, wherein said operating system is configured to return the error upon determining that granting the allocation would cause the amount of memory allocated to said first server program to exceed the limit.

45. The display server according to claim 43, wherein said operating system is configured to return the error upon determining that granting the allocation would cause the process size of said first server program to exceed the limit.

46. The display server according to claim 43, said display server comprising a network interface configured to transmit information into at least one network external to said display server,
wherein said first server program is configured to transmit a signal indicating the error via said network interface.

47. The display server according to claim 1, said display server comprising a user process configured to initiate a restart of one of the first and second server programs upon detecting a termination of the server program.

48. A method of image generation, said method comprising:
within a display server, executing a first server program to output a first plurality of rendering commands;
within the display server, executing a second server program, as a user process separate from the first server program, to output a second plurality of rendering commands separate from the first plurality of rendering commands;
within the display server and over a first period, executing rendering commands of the first plurality on a processing unit to obtain values of pixels of a first display frame; and
over a second period overlapping the first period, executing rendering commands of the second plurality on the processing unit to obtain values of pixels of a second display frame.

49. The method of image generation according to claim 48, said method comprising:
executing the first plurality of rendering commands on the processing unit to obtain a first plurality of pixel values that includes the values of pixels of the first display frame;
executing the second plurality of rendering commands on the processing unit to obtain a second plurality of pixel values that includes the values of pixels of the second display frame;
storing pixel values of the first plurality to a first display buffer;
storing pixel values of the second plurality to a second display buffer; and
operating the display server in one among a first display context and a second display context, said operating comprising outputting a video signal based on pixel values stored in a selected one of the first and second display buffers,
wherein operating the display server in the first display context includes outputting the video signal based on pixel values stored in one among the first and second display buffers, and
wherein operating the display server in the second display context includes outputting the video signal based on pixel values stored in the other among the first and second display buffers.

50. The method of image generation according to claim 49, said method comprising:
receiving, via an input port of the display server, a signal from an input device; and
detecting that the signal received from the input device indicates a particular keyboard event; and
based on said detecting, initiating a change from operating the display server in one among the first and second display contexts to operating the display server in the other among the first and second display contexts.

51. The method of image generation according to any claim 49, said method comprising:
receiving a display context switch command arising from an event external to the display server; and
initiating a change from operating the display server in one among the first and second display contexts to operating the display server in the other among the first and second display contexts in response to the display context switch command.

52. The method of image generation according to any claim 49, said method comprising:
receiving, via a network interface, information from a source external to the display server; and
initiating a change from operating the display server in one among the first and second display contexts to operating the display server in the other among the first and second display contexts according to the information received via the network interface.

53. The method of image generation according to an claim 49, said method comprising:
receiving, via a network interface, information from a source external to the display server;
detecting that the signal received by the network interface includes a display context switch command; and
based on said detecting, initiating a change from operating the display server in one among the first and second display contexts to operating the display server in the other among the first and second display contexts.

54. The method of image generation according to claim 49, wherein said outputting a video signal comprises outputting the video signal to include (A) a series of video frames and (B) a periodic signal that indicates a frame boundary between each consecutive pair of the series of video frames,
said method comprising:
during a first frame period defined by a consecutive pair of the frame boundaries, operating the display server in one among the first and second display contexts, and
during a second frame period defined by a consecutive pair of the frame boundaries and adjacent to the first frame period, operating the display server in the other of the first and second display contexts, and
wherein the duration of the first frame period is substantially equal to the duration of the second frame period.

55. The method of image generation according to claim 48, said method comprising:
receiving, via a network interface, information from a source external to the display server; and
transmitting, via the network interface, information received by the display server from an input device.

56. The method of image generation according to claim 48, said method comprising outputting a video signal including (A) a series of video frames and (B) a periodic signal that indicates a frame boundary between each consecutive pair of the series of video frames, and
wherein said outputting the video signal comprises outputting the video signal to include, during a first frame period defined by a consecutive pair of the frame boundaries, a representation of the first display frame, and
wherein said outputting the video signal comprises outputting the video signal to include, during a second frame period defined by a consecutive pair of the frame boundaries and adjacent to the first frame period, a representation of the second display frame, and
wherein the duration of the first frame period is substantially equal to the duration of the second frame period.

57. The method of image generation according to claim 48, wherein said executing a first server program comprises executing the first server program on a central processing unit, and
wherein said executing a second server program comprises executing the second server program on the central processing unit,
said method comprising:
determining an average use of the central processing unit by the first server program; and
initiating termination of the first server program based on a relation between the determined average use and a threshold value.

58. The method of image generation according to claim 48, said method comprising:
requesting, from an operating system of the display server, allocation of a specified amount of memory to the first server program; and
returning an error from the operating system to the first server program based on a relation among the specified amount, a process size of the first server program, and a predetermined limit.

59. The method of image generation according to claim 48, said method comprising initiating a restart of one of the first and second server programs upon detecting a termination of the server program.

60. A display server comprising:
a first server program configured to output, over a first period, a first plurality of rendering commands;
a second server program configured to execute as a user process separate from the first server program and to output, over a second period overlapping the first period, a second plurality of rendering commands separate from the first plurality of rendering commands; and
a processing unit configured to (A) to output, according to the first plurality of rendering commands, values of pixels of a first display image and (B) to output, according to the second plurality of rendering commands, values of pixels of a second display image.

61. The display server according to claim 60, said display server comprising a graphics controller including said processing unit, a first display buffer configured to store the values of pixels of the first display image, and a second display buffer configured to store the values of pixels of the second display image,
wherein said graphics controller is configured (C) to output a video signal based on pixel values stored in a selected one of the first and second display buffers and (D) to operate in one among a first display context and a second display context, and
wherein, in the first display context, said graphics controller is configured to output the video signal based on pixel values stored in one among the first and second display buffers, and
wherein, in the second display context, said graphics controller is configured to output the video signal based on pixel values stored in the other among the first and second display buffers.

62. The display server according to claim 61, said display server comprising:
an input port configured to receive a signal from an input device; and
a command detector configured to detect that the signal received from the input device indicates a particular keyboard event,
wherein the command detector is configured to initiate a change in the display context of said graphics controller from one among the first and second display contexts to the other among the first and second display contexts upon detecting that the signal received from the input device indicates the particular keyboard event.

63. The display server according to claim 61, wherein said display server is configured to receive a display context switch command arising from an event external to the display server; and
wherein said display server comprises a command detector configured to initiate a change in the display context of said graphics controller from one among the first and second display contexts to the other among the first and second display contexts in response to the display context switch command.

64. The display server according to claim 61, said display server comprising a network interface configured to receive information from a source external to said display server,
wherein said display server is configured to change the display context of said graphics controller from one among the first and second display contexts to the other among the first and second display contexts according to a signal received by said display server via said network interface.

65. The display server according to claim 61, said display server comprising:
a network interface configured to receive a signal from a source external to said display server; and
a command detector configured to detect that the signal received by the network interface includes a display context switch command,
wherein said command detector is configured to initiate a change in the display context of said graphics controller from one among the first and second display contexts to the other among the first and second display contexts upon detecting that the signal received by the network interface includes a display context switch command.

66. The display server according to claim 61, wherein said graphics controller is configured to output the video signal to include (A) a series of video frames and (B) a periodic signal that indicates a frame boundary between each consecutive pair of the series of video frames, and
wherein said graphics controller is configured to output the video signal to include, during a first frame period defined by a consecutive pair of the frame boundaries, a representation of the first display frame, and
wherein said graphics controller is configured to output the video signal to include, during a second frame period defined by a consecutive pair of the frame boundaries and adjacent to the first frame period, a representation of the second display frame, and
wherein the duration of the first frame period is substantially equal to the duration of the second frame period.

67. The display server according to claim 61, wherein said graphics controller is configured to output the video signal to include (A) a series of video frames and (B) a periodic signal that indicates a frame boundary between each consecutive pair of the series of video frames, and
wherein, during a first frame period defined by a consecutive pair of the frame boundaries, said graphics controller is configured to operate in one of the first and second display contexts, and
wherein, during a second frame period defined by a consecutive pair of the frame boundaries and adjacent to the first frame period, said graphics controller is configured to operate in the other of the first and second display contexts, and
wherein the duration of the first frame period is substantially equal to the duration of the second frame period.

68. The display server according to claim 60, said display server comprising a network interface configured to receive information from a source external to said display server,
wherein the first server program is configured to output the first plurality of rendering commands according to a first plurality of drawing requests, received via the network interface, that describes a plurality of graphics primitives of the first display frame, and
wherein at least one of the first and second server programs is configured to transmit, via the network interface, information received by said display server from an input device.

69. The display server according to claim 60, said display server comprising:
a central processing unit configured to execute the first and second server programs; and
a user process configured to determine an average use of the central processing unit by the first server program,
wherein said user process is configured to initiate termination of the first server program based on a relation between the determined average use and a threshold value.

70. The display server according to claim 60, said display server comprising an operating system,
wherein said first server program is configured to request allocation of a specified amount of memory from said operating system, and
wherein said operating system is configured to return an error to said first server program based on a relation among the specified amount, a process size of said first server program, and a predetermined limit.

71. The display server according to claim 60, said display server comprising a user process configured to initiate a restart of one of the first and second server programs upon detecting a termination of the server program.
